(19) United States
(12) Patent Application Publication
(10) Pub. No.: US 2024/0001581 A1
(43) Pub. Date: Jan. 4, 2024

(54) WORK MACHINE

(71) Applicant: Koki Holdings Co., Ltd., Tokyo (JP)

(72) Inventors: Takeru KUMAKURA, Ibaraki (JP); Yoshiaki OSADA, Ibaraki (JP); Ayaka KOIZUMI, Ibaraki (JP)

(73) Assignee: Koki Holdings Co., Ltd., Tokyo (JP)

(21) Appl. No.: 18/034,052

(22) PCT Filed: Oct. 22, 2021
(86) PCT No.: PCT/JP2021/039075

§ 371 Date: Apr. 26, 2023

(30) Foreign Application Priority Data
Oct. 30, 2020 (JP) 2020-182567

(51) Int. Cl. B27C 5/10; B25F 5/02

(52) U.S. Cl. CPC B27C 5/10; B25F 5/02

(57) ABSTRACT

A work machine includes a motor; an output shaft rotated by the motor, to which a tip tool is attachable; a housing, configured to include an inner case including an accommodation part that accommodates the motor and an outer case located outside the accommodation part; and a base, attachable to and detachable from a mounting surface formed on a side surface of the outer case and having a contact surface able to contact a workpiece, wherein the inner case is provided with a fixing part fixing the outer case, and the fixing part is arranged inside the mounting surface in a radial direction of the motor as viewed in an axial direction of the motor.

### TECHNICAL FIELD

The present invention relates to a work machine.

### RELATED ART

In an electrically-powered trimmer (work machine) described in Patent Document 1 below, a cylinder part of a base is externally inserted onto a motor case (housing). A slit is formed in the cylinder part of the base, and a shaft is bridged over between flanges at both circumferential ends of the base. A lever is connected to the shaft. By operating the lever, the cylinder part of the base is deformed so as to tighten the motor case, and the cylinder part is fixed to the motor case.

### PRIOR-ART DOCUMENTS

### Patent Documents

Patent Document 1: Japanese Patent Laid-open No. H10-217203

### SUMMARY OF THE INVENTION

### Problems to be Solved by the Invention

However, in the electrically-powered trimmer, since the cylinder part of the base is deformed so as to tighten the motor case and the cylinder part is fixed to the motor case as described above, there is a possibility that the motor case may be deformed or damaged by a tightening force of the cylinder part with respect to the motor case. As a result, for example, a fixing force of the base may be reduced, and operability may deteriorate. In the electrically-powered trimmer, since the lever provided in the cylinder part of the base is provided in one place, a force from the lever that acts on the cylinder part of the base tends to concentrate on one portion of the cylinder part. As a result, for example, if the base is made of resin, there is a possibility that the portion of the cylinder part of the base may be greatly bent and deformed, and the operability may deteriorate. There is also a problem that, when the lever is operated to release the tightening force of the cylinder part of the base with respect to the motor case, the fixing force of the cylinder part with respect to the motor case may immediately disappear, and the base may fall to the motor case. Accordingly, it is necessary for an operator to carry out an operation of releasing the lever while supporting the base, leading to reduction in the operability. Hence, the electrically-powered trimmer has room for improvement in terms of improving the operability for realizing a suitable fixing structure with respect to the base.

In consideration of the above facts, an object of the present invention is to improve operability of a suitable fixing structure with respect to the base.

### Means for Solving the Problems

According to one or more embodiments of the present invention, a work machine includes: a motor; an output shaft rotated by the motor, to which a tip tool is attachable; a housing, configured to include an inner case including an accommodation part that accommodates the motor and an outer case located outside the accommodation part; and a base, attachable to and detachable from a mounting surface formed on a side surface of the outer case and having a contact surface able to contact a workpiece. The inner case is provided with a fixing part fixing the outer case. The fixing part is arranged inside the mounting surface in a radial direction of the motor as viewed in an axial direction of the motor.

According to one or more embodiments of the present invention, a work machine includes: a motor; an output shaft rotated by the motor, to which a tip tool is attachable; a housing, configured to include an inner case including an accommodation part that accommodates the motor and an outer case located outside the accommodation part; and a base, attachable to and detachable from a mounting surface formed on a side surface of the outer case and having a contact surface able to contact a workpiece. A fixing part fixing the outer case is provided in a portion on one side of the accommodation part in an axial direction of the motor, and an overhang is connected to the other side of the accommodation part. The overhang projects from the mounting surface as viewed in the axial direction of the motor.

According to one or more embodiments of the present invention, in the work machine, an overhang is connected to the other side of the accommodation part in the axial direction of the motor, and the overhang projects radially outward of the mounting surface as viewed in the axial direction of the motor.

According to one or more embodiments of the present invention, in the work machine, the fixing part is arranged inside the mounting surface in the radial direction of the motor as viewed in the axial direction of the motor.

According to one or more embodiments of the present invention, in the work machine, the accommodation part is an inner cylinder part having a cylindrical shape. The outer case is a disassemblable single member and is formed in a cylindrical shape. The inner case is inserted inside the outer case. The fixing part is provided at one end of the inner case in the axial direction of the motor.

According to one or more embodiments of the present invention, in the work machine, a controller controlling the motor is accommodated in the overhang, and the controller projects radially outward of an outer peripheral surface of the outer case as viewed in the axial direction of the outer case.

According to one or more embodiments of the present invention, in the work machine, the overhang is provided with a battery attachment and detachment part to which a battery supplying electric power to the motor is attached, and the battery attachment and detachment part projects outward of the mounting surface as viewed in the axial direction.

According to one or more embodiments of the present invention, in the work machine, a bearing supporting the output shaft is provided inside the inner cylinder part, and the inner case is provided with a bearing holder holding the bearing. The fixing part is formed on the bearing holder.

According to one or more embodiments of the present invention, in the work machine, the inner cylinder part is configured to include a small diameter portion and a large diameter portion having a larger diameter than the small diameter portion. An outer peripheral surface of the large diameter portion is in contact with the outer case.

According to one or more embodiments of the present invention, in the work machine, the large diameter portion is provided on each of both axial sides of the motor with respect to the small diameter portion.

According to one or more embodiments of the present invention, in the work machine, a fan rotated by driving the motor is provided inside the inner case. An airflow generated by the fan flows through between the small diameter portion and the outer case.

According to one or more embodiments of the present invention, in the work machine, a communication part is formed in the large diameter portion, and the communication part communicates inside of the inner case with a space between the small diameter portion and the outer case.

According to one or more embodiments of the present invention, in the work machine, a recess open toward the other side in the axial direction is formed at the other end of the outer case in the axial direction. The inner case is provided with an operating part performing an on or off operation of the motor, and the operating part is arranged in the recess.

According to one or more embodiments of the present invention, in the work machine, a protrusion protruding outward in the radial direction is formed in the inner cylinder part, and a groove fitted with the protrusion and restricting rotation of the outer case with respect to the inner case is formed in the outer case.

According to one or more embodiments of the present invention, in the work machine, the operating part is configured to be able to be pressed radially inward of the inner cylinder part, and the operating part is operated to thereby press a switch provided inside the inner cylinder part.

According to one or more embodiments of the present invention, a work machine includes: a housing, including a cylinder part; a prime mover, accommodated in the housing; an output shaft rotated by the prime mover, to which a tip tool is attachable; a base, including an external insertion part externally inserted onto the cylinder part; and a fixing mechanism, provided in the external insertion part and including a plurality of fixing force imparting parts operated to thereby impart a fixing force that fixes the external insertion part to the cylinder part. The plurality of fixing force imparting parts are arranged apart in the axial direction of the external insertion part.

According to one or more embodiments of the present invention, a work machine includes: a housing, including a cylinder part; a prime mover, accommodated in the housing; an output shaft rotated by the prime mover, to which a tip tool is attachable; a base, including an external insertion part externally inserted onto the cylinder part; and a fixing mechanism, mounted on a clamp part protruding radially outward from the external insertion part and including a fixing force imparting part operated to thereby impart a fixing force that fixes the external insertion part to the cylinder part. The fixing force imparting part generates the fixing force in the external insertion part via a rigid member provided in an upper portion and a lower portion of the clamp part.

According to one or more embodiments of the present invention, a work machine includes: a housing, including a cylinder part; a motor, accommodated in the housing; an output shaft rotated by the motor, to which a tip tool is attachable; a base, externally inserted onto the cylinder part and having a contact surface able to contact a workpiece; a fixing mechanism, provided in the base and operated to thereby switch between a fixed state in which the base is fixed to the housing and a released state in which the fixed state of the base to the housing is released; and a holding mechanism, provided in the base and holding the base in a temporarily fixed state to the housing in the released state of the fixing mechanism.

According to one or more embodiments of the present invention, in the work machine, the holding mechanism holds the base in the temporarily fixed state by frictional force generated between the cylinder part and the base.

According to one or more embodiments of the present invention, in the work machine, the base is configured to include: an external insertion part, externally inserted onto the cylinder part and having a portion formed in a cylindrical shape open radially outward; a first clamp part, constituting one circumferential end of the external insertion part; and a second clamp part, constituting the other circumferential end of the external insertion part. The fixing mechanism connects the first clamp part with the second clamp part. When the fixing mechanism switches from the released state to the fixed state, the first clamp part and the second clamp part are brought closer to each other and the external insertion part is tightened to the cylinder part.

### Effects of the Invention

According to one or more embodiments of the present invention, a work machine having improved operability can be realized.

### BRIEF DESCRIPTION OF THE DRAWINGS

FIG. 1 is a side view of an electrically-powered trimmer according to the present embodiment as viewed from one side in a first direction.

FIG. 2 is a side view of the electrically-powered trimmer shown in FIG. 1 as viewed from one side in a second direction.

FIG. 3 is a side sectional view (sectional view along line 3-3 in FIG. 2) of the electrically-powered trimmer shown in FIG. 2 as viewed from one side in the first direction.

FIG. 4 is a side sectional view (sectional view along line 4-4 in FIG. 1) of the electrically-powered trimmer shown in FIG. 1 as viewed from one side in the second direction.

FIG. 5 is an exploded perspective view of a trimmer body of the electrically-powered trimmer shown in FIG. 2, as viewed from below, with an outer case removed from an inner case.

FIG. 6 is a bottom view of the trimmer body shown in FIG. 5 as viewed from below.

In FIG. 7, (A) is a side view of an inner case shown in FIG. 5 as viewed from one side in the second direction, and (B) is a bottom view of the inner case of (A) as viewed from below.

FIG. 8 is a sectional view (sectional view along line 8-8 in FIG. 1) of a fixing mechanism shown in FIG. 1 as viewed from one side in the second direction.

FIG. 9 is a sectional view (sectional view along line 9-9 in FIG. 1) of the fixing mechanism shown in FIG. 1 as viewed from above.

FIG. 10 is an exploded perspective view of a state in which a fixing washer and a clamp lever of the fixing mechanism shown in FIG. 8 are removed from a fixing shaft.

FIG. 11 is a sectional view (sectional view along line 11-11 in FIG. 1) of a holding mechanism shown in FIG. 1 as viewed from above.

FIG. 12 is a sectional view corresponding to FIG. 9 for describing a state in which a base is temporarily held by a housing by a holding mechanism shown in FIG. 10.

FIG. 13 is a functional block diagram for describing an electrical configuration of a controller in the electrically-powered trimmer according to the present embodiment.

FIG. 14 is a flowchart for describing an operation of the electrically-powered trimmer according to the present embodiment.

FIG. 15 is a sectional view of a modification shown in FIG. 10.

FIG. 16 is a side view of Modification 1 of a fixing mechanism shown in FIG. 2 as viewed from one side in the second direction.

FIG. 17 is a side view of Modification 2 of the fixing mechanism shown in FIG. 2 as viewed from one side in the second direction.

FIG. 18 is a sectional view of Modification 2 of the fixing mechanism shown in FIG. 17 as viewed from one side in the second direction.

### DESCRIPTION OF THE EMBODIMENTS

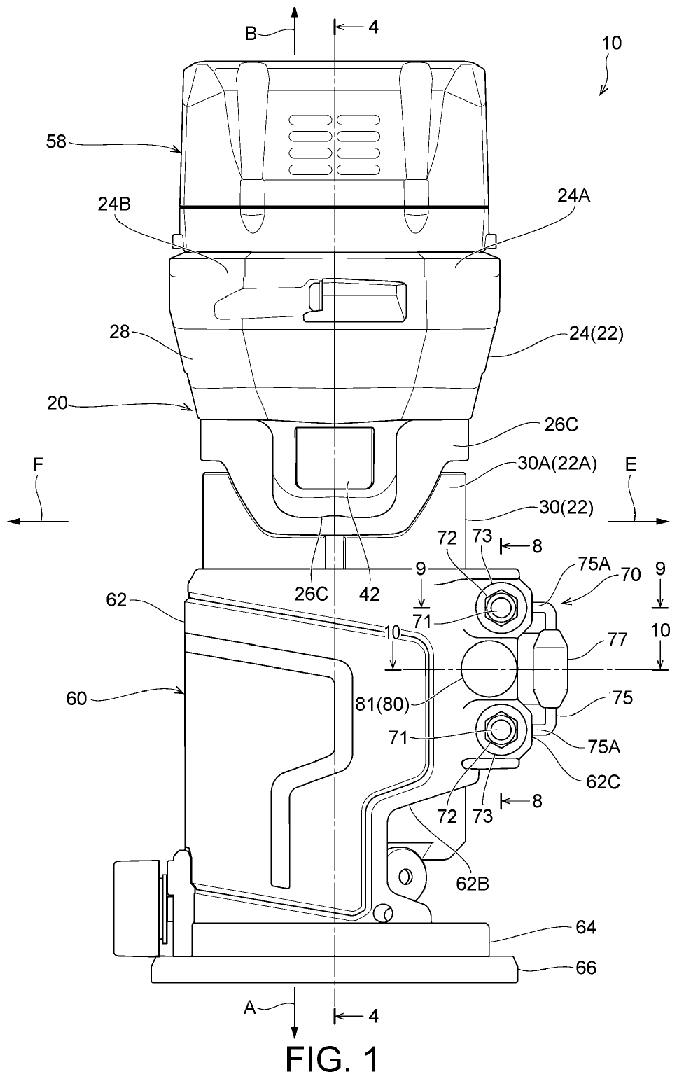

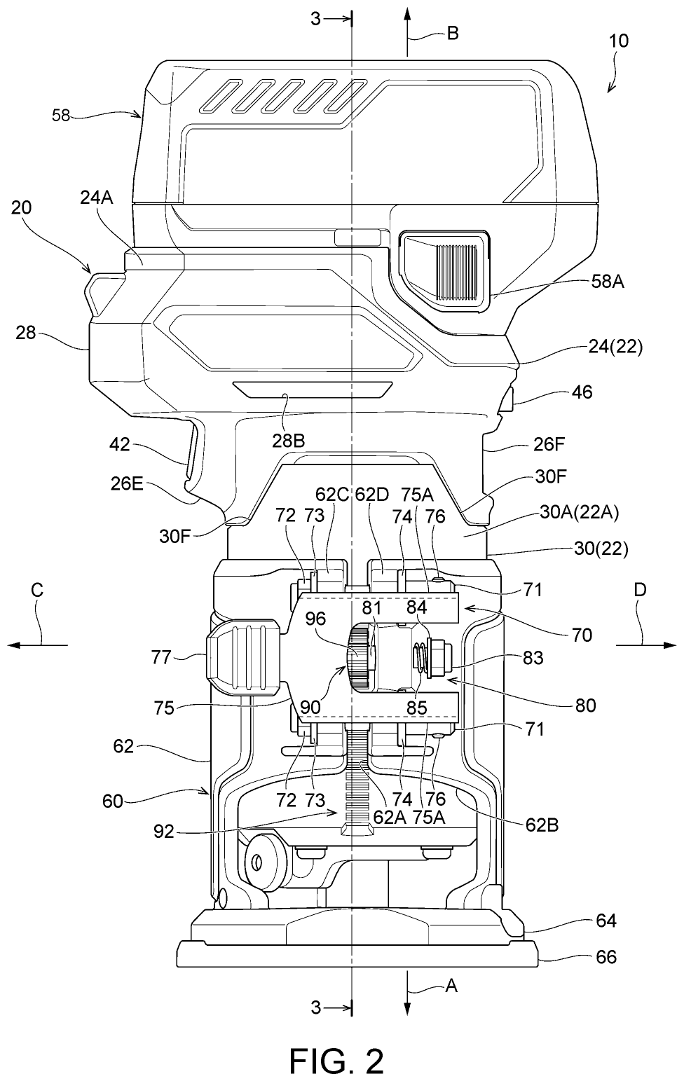

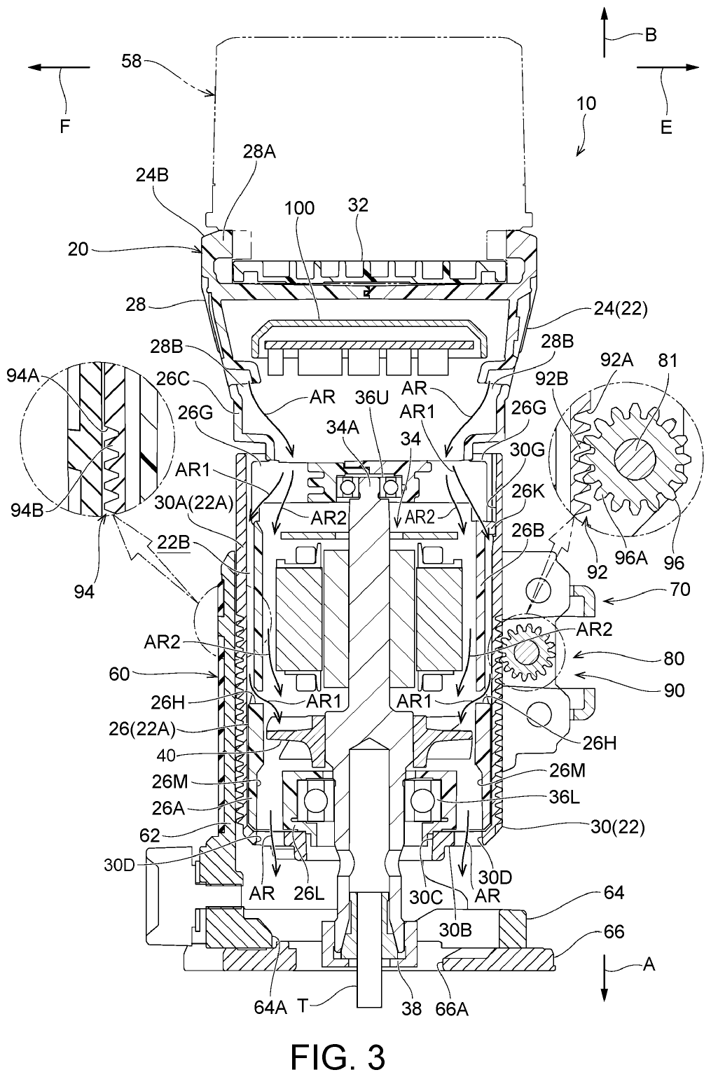

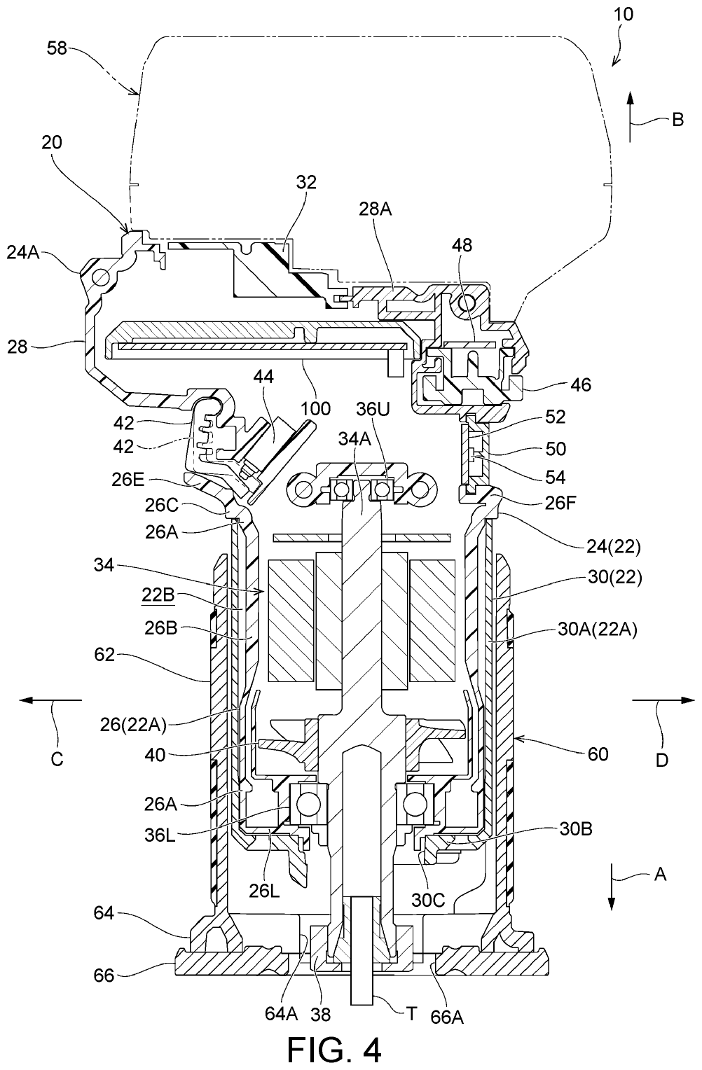

An electrically-powered trimmer 10 as a work machine according to the present embodiment will be described below with reference to the drawings. As shown in FIG. 1 to FIG. 4, the electrically-powered trimmer 10 is formed in a substantially columnar shape as a whole. In the following description, one side (side in the direction of arrow A in FIG. 1 to FIG. 4) of the electrically-powered trimmer 10 in an axial direction is taken as a lower side of the electrically-powered trimmer and the other side (side in the direction of arrow B in FIG. 1 to FIG. 4) of the electrically-powered trimmer 10 in the axial direction is taken as an upper side of the electrically-powered trimmer 10. In plan view from above, a direction orthogonal to an up-down direction is taken as a first direction (see arrow C and arrow D in FIG. 2 and FIG. 4), and a direction orthogonal to the first direction is taken as a second direction (see arrow E and arrow F in FIG. 1 and FIG. 3).

The electrically-powered trimmer 10 is configured as a tool that performs cutting of a workpiece arranged below the electrically-powered trimmer 10. The electrically-powered trimmer is configured to include a trimmer body 20, a base 60, a battery 58 as a battery, a fixing mechanism a holding mechanism 80, a lifting mechanism 90 as a position changing mechanism, and a controller 100. Each configuration of the electrically-powered trimmer 10 will be described below.

(Regarding Trimmer Body 20)

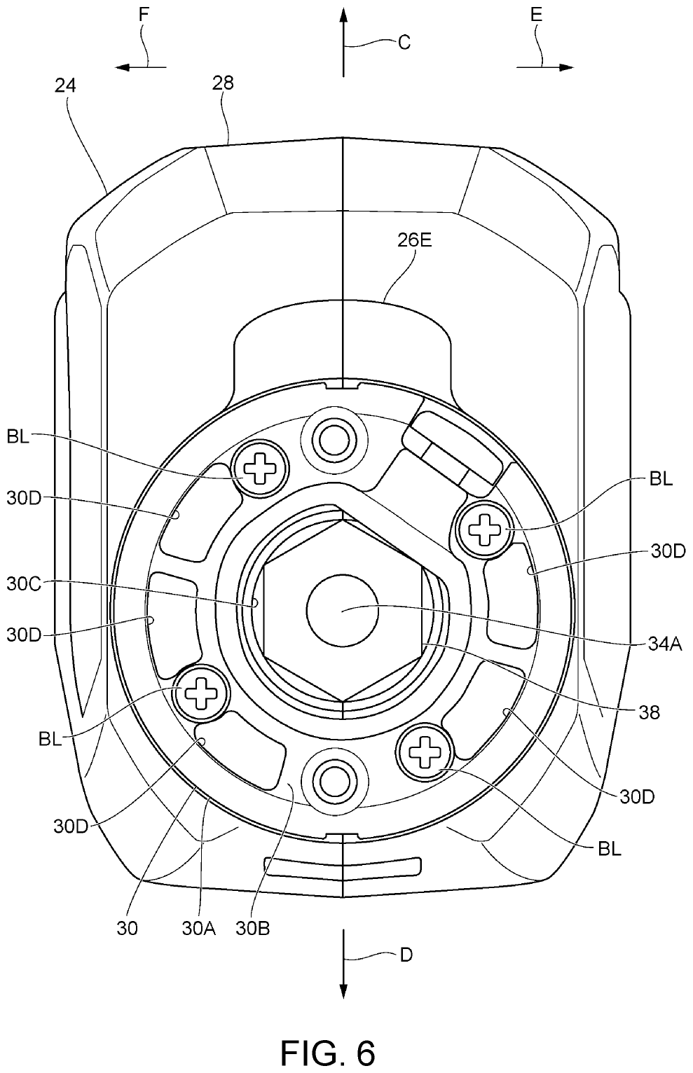

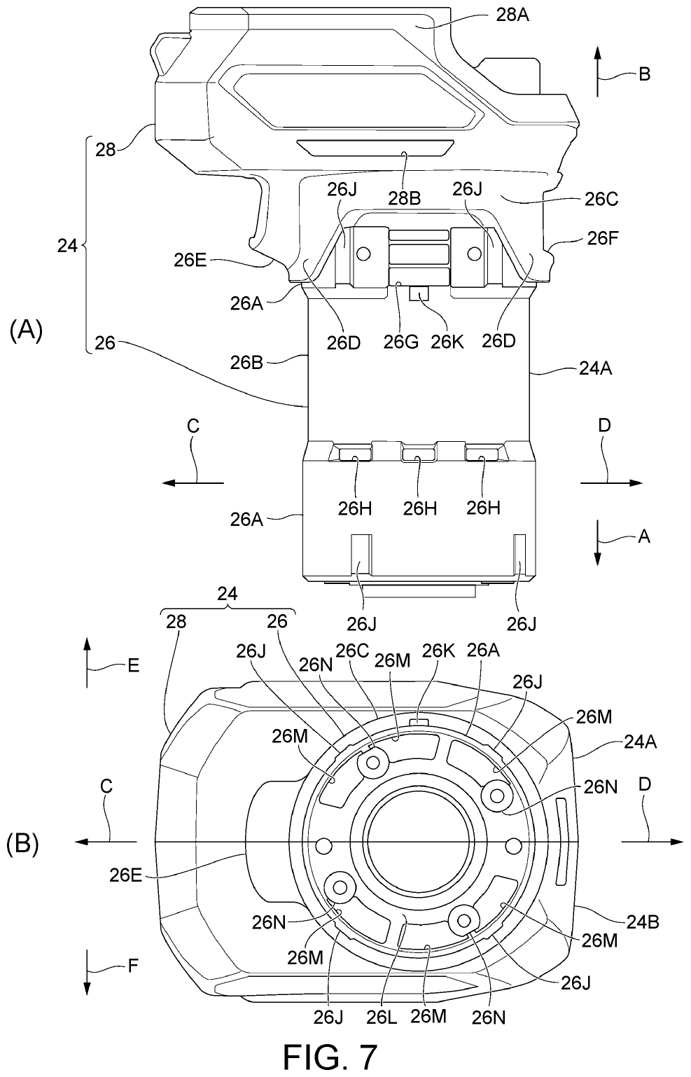

As shown in FIG. 1 to FIG. 6, the trimmer body 20 is configured to include a housing 22, a motor 34 as a prime mover, a trigger 42 as an operating part, a speed setting dial 46, and a lock button 50 as a state switcher.

<Regarding Housing 22>

The housing 22 constitutes an outer shell of the trimmer body 20. The housing 22 has a double structure. Specifically, the housing 22 is configured to include an inner case 24 constituting an inner peripheral portion of the housing 22 and an outer case 30 constituting an outer peripheral portion of the housing 22.

As shown in FIG. 3 to FIG. 7, the inner case 24 is made of resin. The inner case 24 is formed in a substantially bottomed cylindrical shape open downward. Specifically, the inner case 24 is configured to include an upper case part 28 as an overhang constituting an upper end of the inner case 24 and an inner cylinder part 26 having a cylindrical shape extending downward from the upper case part 28. The upper case part 28 is formed in a substantially rectangular shape as viewed from below, and projects from the inner cylinder part 26 toward one side in the first direction (side in the direction of arrow C in FIG. 4 and FIG. 7(A)).

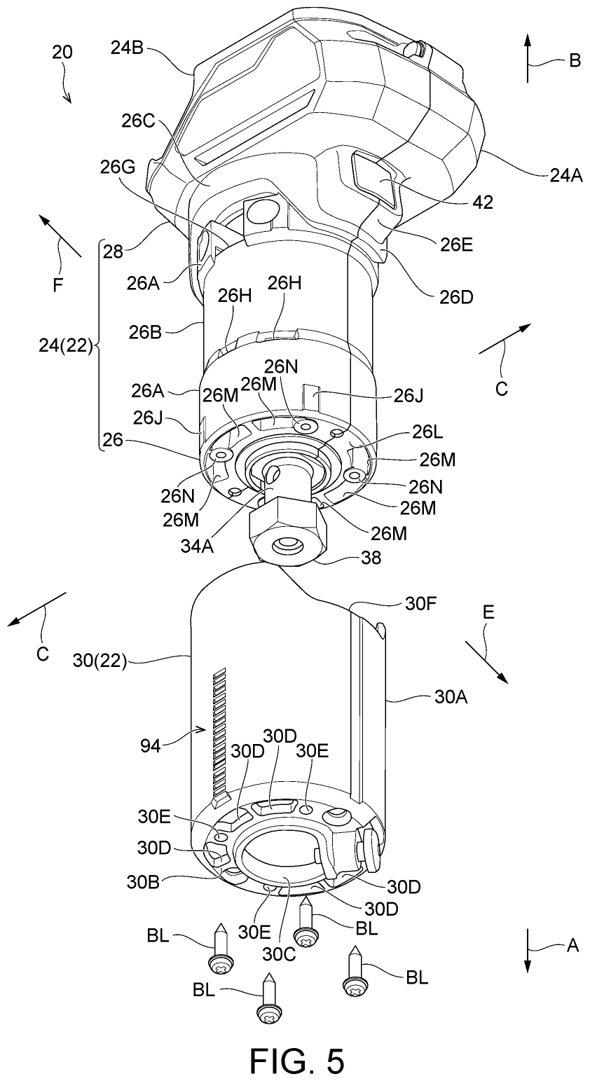

The inner case 24 is divided into two in the second direction. In detail, the inner case 24 is configured to include a first inner case 24A constituting a portion on one side in the second direction (side in the direction of arrow E in FIG. 5 to FIG. 7) of the inner case 24, and a second inner case 24B constituting a portion on the other side in the second direction (side in the direction of arrow F in FIG. 5 to FIG. 7) of the inner case 24. The first inner case 24A and the second inner case 24B are fastened and fixed with their respective openings butt against each other.

The inner cylinder part 26 is configured to include a pair of large diameter portions 26A constituting an upper end and a lower end of the inner cylinder part 26, and a small diameter portion 26B constituting a vertically intermediate portion of the inner cylinder part 26. A diameter of the small diameter portion 26B is set smaller than a diameter of the large diameter portion 26A. At an upper end of the large diameter portion 26A on the upper side, an inner cylinder expanded portion 26C is formed one-step raised radially outward. In portions on one side and the other side in the first direction of the inner cylinder expanded portion 26C, a pair of expanded protrusions 26D protruding downward are formed. Accordingly, a lower end of the inner cylinder expanded portion 26C is formed uneven as viewed from radially outside the inner cylinder part 26.

A trigger mounting part 26E for mounting a trigger 42 described later is formed on the expanded protrusion 26D on one side in the first direction. The trigger mounting part 26E protrudes toward one side in the first direction with respect to the expanded protrusion 26D. A button mounting part 26F for mounting a lock button 50 described later is formed on the expanded protrusion 26D on the other side in the first direction. The button mounting part 26F is one-step lowered radially inward with respect to the expanded protrusion 26D.

An upper communication hole 26G (see FIG. 3 and FIG. 7(A)) as a communication part is formed penetrating portions on one side and the other side in the second direction of the large diameter portion 26A on the upper side. Specifically, the upper communication hole 26G is arranged between the pair of expanded protrusions 26D. The upper communication hole 26G is formed in a rectangular shape as viewed from radially outside the inner cylinder part 26, and an opening of the upper communication hole 26G is open downward. At a boundary portion between the large diameter portion 26A on the lower side and the small diameter portion 26B, three lower communication holes 26H (see FIG. 3, FIG. 5, and FIG. 7(A)) are respectively formed penetrating portions on one side and the other side in the second direction. That is, six lower communication holes 26H are formed in the inner cylinder part 26. The lower communication holes 26H are formed in an elongated hole shape extending in the circumferential direction of the inner cylinder part 26, and are arranged side by side in the circumferential direction of the inner cylinder part 26. The lower communication hole 26H is a communication part in the present invention.

A plurality of (four in the present embodiment) contact parts 26J (see FIG. 5 and FIG. 7) are respectively formed on an outer periphery of the pair of large diameter portions 26A. That is, eight contact parts 26J are formed in the inner cylinder part 26 in the present embodiment. The contact part 26J is formed in a substantially rectangular shape with the up-down direction as the longitudinal direction as viewed from radially outside the inner cylinder part 26, and slightly protrudes radially outward with respect to the large diameter portion 26A. The contact parts 26J are arranged at equal intervals in the circumferential direction of the inner cylinder part 26. At an upper end of the small diameter portion 26B, a protrusion 26K (see FIG. 3 and FIG. 7) protruding radially outward is formed at the opening of the upper communication hole 26G on one side in the second direction.

A bearing holder 26L for holding a second bearing 36L described later is formed at the lower end of the inner cylinder part 26. The bearing holder 26L is formed in a substantially annular plate shape with the up-down direction as a plate thickness direction, and extends radially inward from the lower end of the inner cylinder part 26. In portions on one side and the other side in the second direction of the bearing holder 26L, a plurality of (five in the present embodiment) inner exhaust ports 26M are respectively formed. Specifically, three inner exhaust ports 26M are formed in the portion on one side in the second direction of the bearing holder 26L, and two inner exhaust ports 26M are formed in the portion on the other side in the second direction of the bearing holder 26L. The inner exhaust ports 26M are formed in an elongated hole shape extending in the circumferential direction of the inner cylinder part 26, and are arranged side by side in the circumferential direction of the inner cylinder part 26. On the bearing holder 26L, a plurality of (four in the present embodiment) fixing bosses 26N for fixing the outer case 30 described later are formed. The fixing bosses 26N are formed in a cylindrical shape with the up-down direction as the axial direction, and are arranged at equal intervals in the circumferential direction of the inner cylinder part 26 and between the inner exhaust ports 26M. Accordingly, the fixing boss 26N for fixing the outer case 30 described later is arranged radially inside an outer peripheral surface of the inner cylinder part 26. The fixing boss 26N is a fixing part in the present invention.

In the upper case part 28, a battery mounting part 28A as a battery attachment and detachment part for mounting the battery 58 described later is formed. The battery mounting part 28A is formed in a concave shape open upward and toward the other side in the first direction. The upper case part 28 is provided with a connector 32 (see FIG. 3 and FIG. 4). The connector 32 is exposed inside the battery mounting part 28A.

An intake port 28B (see FIG. 2 and FIG. 3) is formed penetrating a lower end portion of a sidewall on both sides in the second direction of the upper case part 28. The intake port 28B is formed in an elongated hole shape with the first direction as the longitudinal direction. That is, the intake port 28B is arranged above the upper communication hole 26G of the inner case 24.

As shown in FIG. 1 to FIG. 6, the outer case 30 is made of metal and is composed of a disassemblable single member. The outer case 30 is formed in a substantially bottomed cylindrical shape open downward with the up-down direction as the axial direction. Specifically, the outer case is configured to include an outer cylinder part 30A having a cylindrical shape and a case bottom constituting a lower end of the outer case 30. The outer cylinder part 30A is externally inserted onto the inner cylinder part 26 of the inner case 24. The inner cylinder part 26 and the outer cylinder part 30A constitute a cylinder part 22A of the housing 22. The term “externally inserted” herein indicates a manner in which an outer peripheral portion of a target is inserted inside, and indicates a state in which the outer cylinder part 30A has the inner cylinder part 26 inserted inside thereof.

An insertion part 30C is formed penetrating a central portion of the case bottom 30B. Five outer exhaust ports 30D are formed penetrating the case bottom 30B at positions corresponding to the inner exhaust port 26M of the inner case 24. The outer exhaust port 30D corresponds to the inner exhaust port 26M and is formed in an elongated hole shape with the circumferential direction of the outer cylinder part 30A as the longitudinal direction. Accordingly, the inside and the outside of the inner case 24 are communicated by the inner exhaust port 26M and the outer exhaust port 30D. Furthermore, four fixing holes 30E (see FIG. 5) are formed penetrating the case bottom 30B at positions corresponding to the fixing boss 26N of the inner case 24. By inserting a fixing bolt BL (in a broad sense, an element grasped as a fixing member) into the fixing hole 30E from below and screwing it to the fixing boss 26N, the outer case 30 is fixed to the inner case 24.

At an upper end of the outer case 30, a case gouged portion 30F as a pair of recesses is formed in a position corresponding to the expanded protrusion 26D of the inner case 24. The case gouged portion 30F is formed in a concave shape open upward, and is formed in a trapezoidal shape as viewed from radially outside the outer case 30. In a state of fixing the outer case 30 to the inner case 24, the upper end of the outer case 30 is arranged below the inner cylinder expanded portion 26C of the inner case 24, and the outer cylinder part 30A covers the portion of the inner cylinder part 26 of the inner case 24 excluding the inner cylinder expanded portion 26C from radially outside. That is, the upper communication hole 26G is covered by the upper end of the outer case 30 so as to be invisible.

In the state of fixing the outer case 30 to the inner case 24, an inner peripheral surface of the outer cylinder part 30A is in contact with the contact part 26J of the inner case 24. Accordingly, a gap 22B (see FIG. 3 and FIG. 4) is formed between the small diameter portion 26B and the outer case 30 in the cylinder part 22A. The gap 22B is formed over the entire circumference of the cylinder part 22A in the circumferential direction. An upper end of the gap 22B communicates with the inside of the inner case 24 through the upper communication hole 26G. A lower end of the gap 22B communicates with the inside of the inner case 24 through the lower communication hole 26H. A diameter of the outer cylinder part 30A is set so that an outer peripheral surface of the outer cylinder part 30A is flush with an outer peripheral surface of the inner cylinder expanded portion 26C of the inner case 24.

On the inner peripheral surface at the upper end of the outer cylinder part 30A, an engagement groove 30G (see FIG. 3) as a groove is formed in a position corresponding to the protrusion 26K of the inner case 24. The engagement groove 30G extends in the up-down direction and is open upward. The following configuration is achieved: when the outer case 30 is externally inserted onto the inner case 24, the protrusion 26K is inserted into the engagement groove 30G, and the protrusion 26K and the engagement groove 30G are engaged in the circumferential direction of the inner case 24.

As shown in FIG. 2, FIG. 3 and FIG. 5, a first rack 92 and a second rack 94 as a pair of racks constituting the lifting mechanism 90 described later are formed on an outer periphery of the outer cylinder part 30A. The first rack 92 is formed in a portion on one side in the second direction of the outer cylinder part 30A. The second rack 94 is formed in a portion on the other side in the second direction of the outer cylinder part 30A. The first rack 92 and the second rack 94 extend in the up-down direction. That is, the first rack 92 and the second rack 94 are arranged 180 degrees apart in the circumferential direction of the outer cylinder part 30A.

The first rack 92 has a plurality of rack grooves 92A. The rack groove 92A extends in the circumferential direction of the outer cylinder part 30A and is open radially outward of the outer cylinder part 30A. The plurality of rack grooves 92A are arranged side by side at equal intervals in the up-down direction. A portion between the rack grooves 92A adjacent to each other in the up-down direction is configured as a rack tooth 92B. Accordingly, in the first rack 92, a plurality of rack teeth 92B are arranged side by side at equal intervals in the up-down direction.

The second rack 94 is configured in the same manner as the first rack 92. That is, the second rack 94 has a plurality of rack grooves 94A arranged side by side in the up-down direction. In the second rack 94, a portion between the rack grooves 94A adjacent to each other in the up-down direction is configured as a rack tooth 94B. A plurality of rack teeth 94B are arranged side by side at equal intervals in the up-down direction.

<Regarding Motor 34>

As shown in FIG. 3 and FIG. 4, the motor 34 is configured as a brushless motor. Inside the inner cylinder part 26 of the inner case 24, the motor 34 is arranged coaxially with the inner cylinder part 26 and below the intake port 28B and the upper communication hole 26G, and is fixed to the inner cylinder part 26. An upper end of an output shaft 34A of the motor 34 is rotatably supported by a first bearing 36U provided in the inner cylinder part 26. On the other hand, a lower end portion of the output shaft 34A is rotatably supported by a second bearing 36L as a bearing. The second bearing 36L is held by the bearing holder 26L of the inner cylinder part 26. The lower end (tip) of the output shaft 34A protrudes downward from a lower end of the housing 22. A collet chuck 38 is provided at the lower end of the output shaft 34A. By the collet chuck 38, a tip tool T is detachably fixed to the lower end of the output shaft 34A. Furthermore, the following configuration is achieved: the motor 34 is electrically connected to a control part 101 described later, and the motor 34 is driven by the control part 101. Accordingly, the workpiece may be subjected to cutting by the tip tool T that rotates with the output shaft 34A. The collet chuck 38 corresponds to a tool holder of the present invention.

A fan 40 is provided on the output shaft 34A of the motor 34 above the second bearing 36L so as to be integrally rotatable therewith. The fan 40 is configured as a so-called axial fan and is configured to generate a downward airflow in the inner case 24. Accordingly, the following configuration is achieved: as cooling air AR flows into the inner case 24 from the intake port 28B, the cooling air AR is discharged to the outside of the housing 22 from the inner exhaust port 26M of the inner case 24 and the outer exhaust port 30D of the outer case 30.

<Regarding Trigger 42>

As shown in FIG. 4, the trigger 42 is configured as an operating part for driving or stopping the motor 34. The trigger 42 is mounted on the trigger mounting part 26E of the inner case 24 and is exposed to one side in the first direction so as to be able to be operated. An upper end of the trigger 42 is rotatably supported by the inner case 24 with the second direction as the axial direction. Accordingly, the trigger 42 is configured to be rotatable between an initial position (position indicated by a solid line in FIG. 4) and an operation position (position indicated by a chain double-dashed line in FIG. 4) achieved by counterclockwise rotation from the initial position as viewed from one side in the second direction. The trigger 42 is energized toward the initial position by an energizing spring (not shown). The trigger 42 is held in the initial position in a non-operation state of the trigger 42.

A microswitch 44 as a switch is provided on the other side of the trigger 42 in the first direction. The microswitch 44 is electrically connected to the control part 101 described later. The following configuration is achieved: as the trigger 42 is operated from the initial position to the operation position, a lower end of the trigger 42 presses the microswitch 44, and the microswitch 44 outputs a detection signal to the control part 101.

<Regarding Speed Setting Dial 46>

The speed setting dial 46 is configured as a dial for changing a rotational speed of the motor 34. The speed setting dial 46 is formed in a substantially disk shape with the up-down direction as the plate thickness direction, and is rotatably supported by the inner case 24 with the up-down direction as the axial direction in a portion on the other side in the first direction of the upper case part 28 of the inner case 24. The speed setting dial 46 is exposed from the upper case part 28 to the other side in the first direction so as to be able to be operated.

An encoder 48 for detecting a rotation position of the speed setting dial 46 is provided above the speed setting dial 46. The encoder 48 is electrically connected to the control part 101. The following configuration is achieved: as the speed setting dial 46 rotates, a detection signal corresponding to the rotation position of the speed setting dial 46 is output from the encoder 48 to the control part 101.

<Regarding Lock Button 50>

The lock button 50 is provided on the button mounting part 26F of the inner case 24 and is exposed from the button mounting part 26F to the other side in the first direction. The lock button 50 is formed in a substantially rectangular shape as viewed from the other side in the first direction, and is composed of an elastic member. A button board 52 is provided adjacent to the lock button 50 on one side in the first direction. A tact switch 54 is mounted on the button board 52. The tact switch 54 is electrically connected to the control part 101 described later. The following configuration is achieved: as the lock button 50 is pressed, the tact switch 54 outputs a detection signal to the control part 101. While details will be described later, the lock button 50 is configured as a button that prohibits or permits driving of the motor 34 when the battery 58 is connected to the connector 32 of the housing 22. The lock button 50 is also configured as a button that continues or stops driving of the motor 34 while the motor 34 is being driven.

(Regarding Base 60)

As shown in FIG. 1 to FIG. 4, the base 60 is made of metal and is formed in a substantially bottomed cylindrical shape open upward. Specifically, the base 60 is configured to include a base cylinder 62 as an external insertion part and a plate 64 constituting a lower end of the base 60.

The base cylinder part 62 is formed in a substantially cylindrical shape with the up-down direction as the axial direction, and a portion of the base cylinder part 62 in the circumferential direction is open. That is, a slit 62A extending in the up-down direction is formed in the base cylinder part 62, and the slit 62A penetrates in the up-down direction and a radial direction of the base cylinder part 62. A width dimension of the slit 62A is set greater than a width dimension of the first rack 92 and the second rack 94. The base cylinder part 62 (base 60) is externally inserted from below onto the cylinder part 22A of the housing 22, and is fixed to the cylinder part 22A by the fixing mechanism 70 described later. Specifically, in a fixed state of the base 60 to the housing 22, the first rack 92 or the second rack 94 is arranged inside the slit 62A as viewed from radially outside the base cylinder part 62. The cylinder part 22A of the housing 22 and the base cylinder part 62 are configured as a grip gripped by the operator.

An opening 62B is formed in a portion on one side in the second direction at a lower end of the base cylinder part 62. The opening 62B is formed in a concave shape open downward as viewed from one side in the second direction. A lower end of the slit 62A communicates with the opening 62B. Accordingly, the following configuration is achieved: while the base 60 is connected to the housing 22, the tip tool T fixed to the output shaft 34A is visible from the opening 62B.

A first clamp part (first chuck part) 62C is provided at one circumferential end of the base cylinder part 62, and a second clamp part 62D is provided at the other circumferential end of the base cylinder part 62. The first clamp part 62C and the second clamp part (second chuck part) 62D are formed in a substantially long block shape with the up-down direction as the longitudinal direction, and extend downward while protruding toward one side in the second direction. The first clamp part (first chuck part) 62C and the second clamp part (second chuck part) 62D correspond to a clamp part or chuck part in the present invention. The clamp part (chuck part) is a portion of the base 60 protruding radially outward from the base cylinder part 62 and extending in the axial direction.

The plate 64 is formed in a substantially rectangular plate shape with the up-down direction as the plate thickness direction, and is connected to the lower end of the base cylinder part 62. A base insertion part 64A (see FIG. 3 and FIG. 4) for insertion of the output shaft 34A and the tip tool T is formed penetrating a substantially central portion of the plate 64. A lower surface of the plate 64 is configured as a contact surface that contacts the workpiece during machining of the workpiece.

A bevel base 66 is provided below the plate 64. The bevel base 66 is formed in a substantially rectangular plate shape with the up-down direction as the plate thickness direction. The bevel base 66 is fixed to the plate 64 with a fixing member such as a screw. Like the plate 64, the bevel base 66 has a bevel insertion part 66A (see FIG. 3 and FIG. 4) formed penetrating therethrough for insertion of the tool T.

(Regarding Battery 58)

As shown in FIG. 1 and FIG. 2, the battery 58 is formed in a substantially rectangular parallelepiped shape. The battery 58 is attached to the battery mounting part 28A of the housing 22 from the other side in the first direction. The battery 58 includes a connector (not shown), and the following configuration is achieved: in a state in which the battery 58 is attached to the battery mounting part 28A, the connector is connected to the connector 32, and electric power is supplied from the battery 58 to the control part 101. The battery 58 includes a pair of lock members 58A. The lock member 58A is provided on one side portion and the other side portion of the battery 58 in the second direction. In the state in which the battery 58 is attached to the battery mounting part 28A, the lock member 58A is engaged with the upper case part 28 of the housing 22, and movement of the battery 58 toward the other side in the first direction is restricted.

(Regarding Fixing Mechanism 70)

As shown in FIG. 1 to FIG. 3 and FIG. 8 to FIG. 10, the fixing mechanism 70 is provided in the base and configured as a mechanism operated to thereby switch between the fixed state of the base 60 to the housing 22 and a released state in which fixation of the base 60 to the housing 22 is released. The fixing mechanism 70 is configured to include an upper-lower pair of fixing shafts 71 and a clamp lever 75. The fixing shaft 71 is formed in a substantially columnar shape with the first direction as the axial direction, and is bridged over between upper ends and lower ends of the first clamp part 62C and the second clamp part 62D of the base 60 so as to be relatively movable in the first direction. One end of the fixing shaft 71 protrudes from the first clamp part 62C toward one side in the first direction. A male thread is formed at one end of the fixing shaft 71. A fixing nut 72 is screwed to one end of the fixing shaft 71 and arranged on one side of the first clamp part 62C in the first direction. A first fixing washer 73 (engagement washer 73) is attached to one end of the fixing shaft 71. The first fixing washer 73 is arranged between the fixing nut 72 and the first clamp part 62C. Accordingly, one end of the fixing shaft 71 is engaged with the first clamp part 62C, and movement of the fixing shaft 71 toward the other side in the axial direction is restricted.

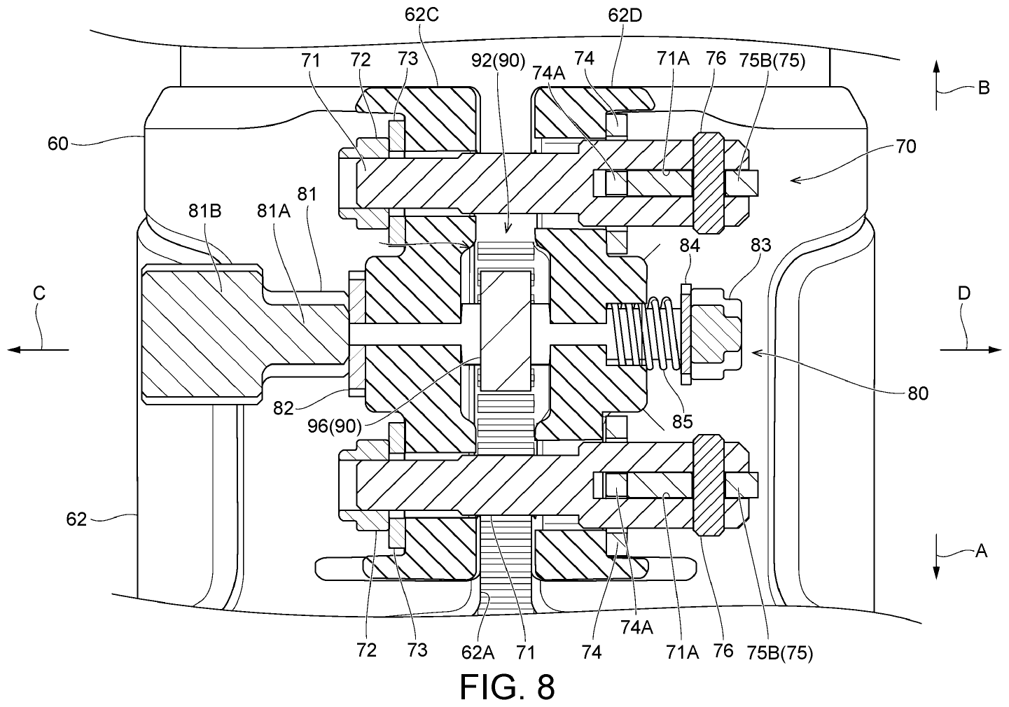

The other end of the fixing shaft 71 protrudes from the second clamp part 62D toward the other side in the first direction. A connecting groove 71A (see FIG. 8) is formed at the other end of the fixing shaft 71. The connecting groove 71A is open toward the other side in the first direction and penetrates in the second direction. A groove depth of the connecting groove 71A is set so that a bottom of the connecting groove 71A is arranged inside the second clamp part 62D.

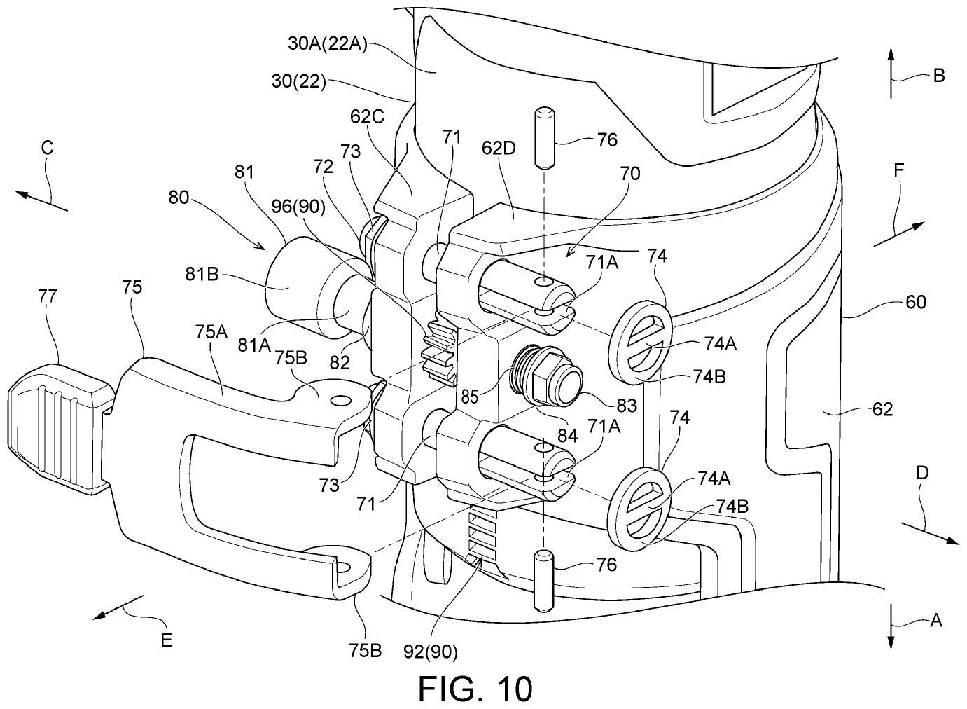

A second fixing washer 74 (fixing washer 74) as a fixing force imparting part is attached to the other end of the fixing shaft 71. The second fixing washer 74 is arranged adjacent to the second clamp part 62D on the other side in the first direction. That is, a pair of second fixing washers 74 are arranged apart in the up-down direction, and are arranged adjacent to both longitudinal ends of the second clamp part 62D on the other side in the first direction. The second fixing washer 74 is configured to include a washer contact part 74A (see FIG. 10) as a contact part extending in the second direction, and a washer pressing part 74B (see FIG. 10) as a pressing part formed in an annular shape and to which both ends of the washer contact part 74A are connected. The washer contact part 74A is arranged inside the connecting groove 71A, and the washer pressing part 74B is externally inserted onto the other end of the fixing shaft 71. The first fixing washer 73 (engagement washer 73) and the second fixing washer 74 correspond to a rigid member of the present invention.

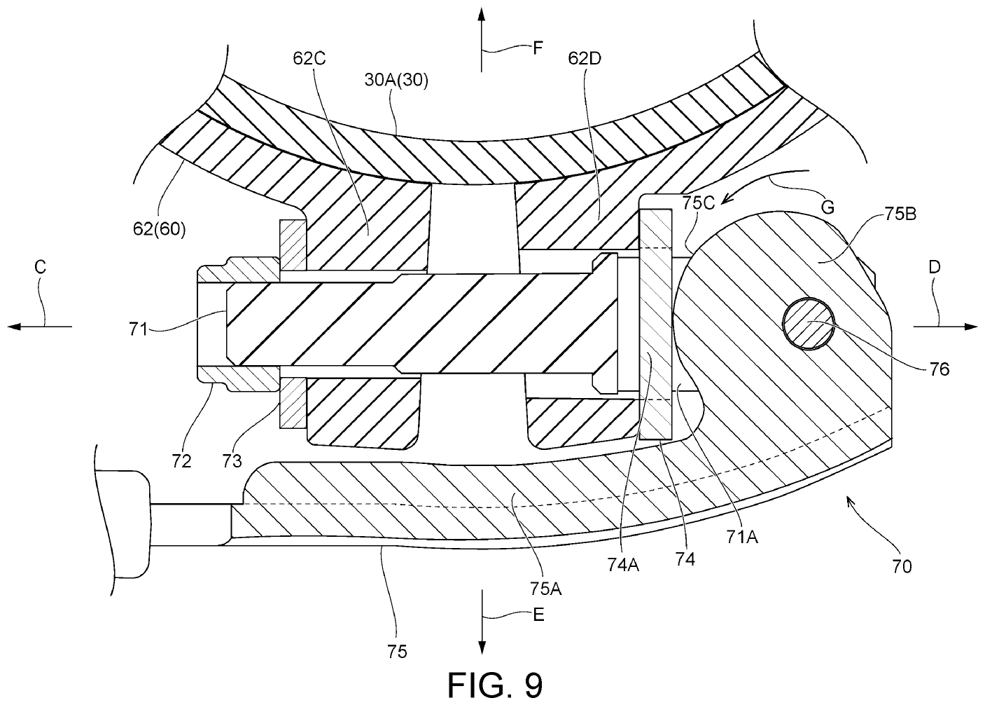

As viewed in the second direction, the clamp lever 75 is formed in a substantially Y-shaped plate shape with the second direction as the plate thickness direction and open toward the other side in the first direction. The clamp lever 75 is arranged on one side of the first clamp part 62C and the second clamp part 62D in the second direction. The clamp lever 75 is inclined toward the other side in the second direction toward the other side in the first direction as viewed from above, and is curved in a substantially arc shape (see FIG. 9). A bend 75A bent toward the other side in the second direction is formed at an upper end and a lower end of the clamp lever 75. A cam part 75B (see FIG. 9) protruding toward the other side in the second direction is formed at an end of the bend 75A toward the other side in the first direction. The cam part 75B is inserted into the connecting groove 71A of the fixing shaft 71, and is rotatably supported by a fixing pin 76 provided on the fixing shaft 71 and with the up-down direction as the axial direction.

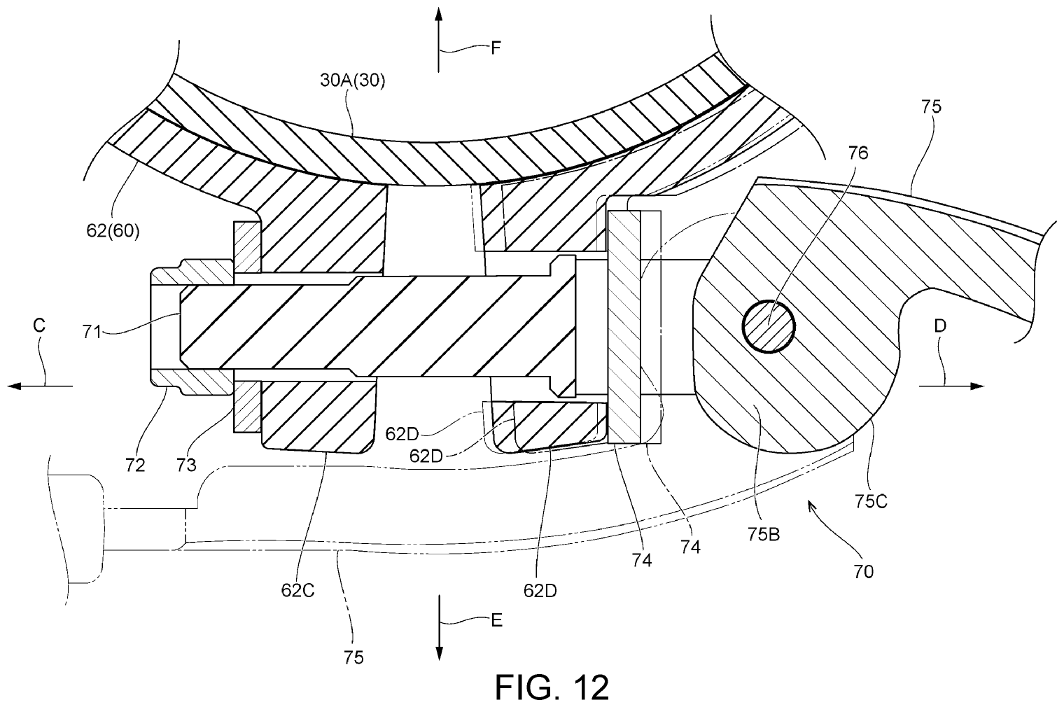

Accordingly, the clamp lever 75 is configured to be rotatable between a fixing position (position shown in FIG. 9) and a release position (position shown in FIG. 12) achieved by rotation from the fixing shaft 71 toward one side in a rotation direction (side in the direction of arrow G in FIG. 9). An outer periphery of the cam part 75B is configured as a cam surface 75C. The cam surface 75C is formed in a substantially arc shape centering on the fixing pin 76 as viewed from above. More specifically, a radius of the cam surface 75C from the fixing pin 76 may increase toward one side in the rotation direction of the clamp lever 75.

The following configuration is achieved: in the fixing position of the clamp lever 75, the cam surface 75C contacts the washer contact part 74A of the second fixing washer 74, and presses the washer contact part 74A toward one side in the first direction. On the other hand, the following configuration is achieved: in the release position of the clamp lever 75, the cam surface 75C is arranged apart from the washer contact part 74A on the other side in the first direction, and pressing of the cam surface 75C against the washer contact part 74A is released. Accordingly, the following configuration is achieved: as the clamp lever 75 is rotated from the release position to the fixing position, by a pressing force of the cam part 75B on the second clamp part 62D via the second fixing washer 74, the base cylinder part 62 is deformed so that the second clamp part 62D is displaced toward the first clamp part 62C. As a result, in the fixing position of the clamp lever 75, a clamping force is generated with which the base cylinder part 62 tightens the cylinder part 22A of the housing 22. By the clamping force, the base 60 is fixed to the housing 22 (outer cylinder part 30A) (this state is hereinafter referred to as fixed state). In the release position of the clamp lever 75, the clamping force of the base cylinder part 62 is released, and the fixed state of the base 60 to the housing 22 is released (this state is hereinafter referred to as released state). Accordingly, the following configuration is achieved: by rendering the fixing mechanism 70 in the released state, a position of the base 60 with respect to the housing 22 in the up-down direction can be variable. A portion of the outer cylinder part 30A that receives the clamping force is a region where the base 60 can be mounted, and the portion functions as a mounting surface of the base 60.

A lever cap 77 is provided at a tip (one end in the first direction) of the clamp lever 75. The tip of clamp lever 75 is covered with the lever cap 77. The tip of the clamp lever 75 is configured as a lever operating part of the clamp lever 75. The operator may grip the lever cap 77 and rotate the clamp lever 75.

(Regarding Holding Mechanism 80)

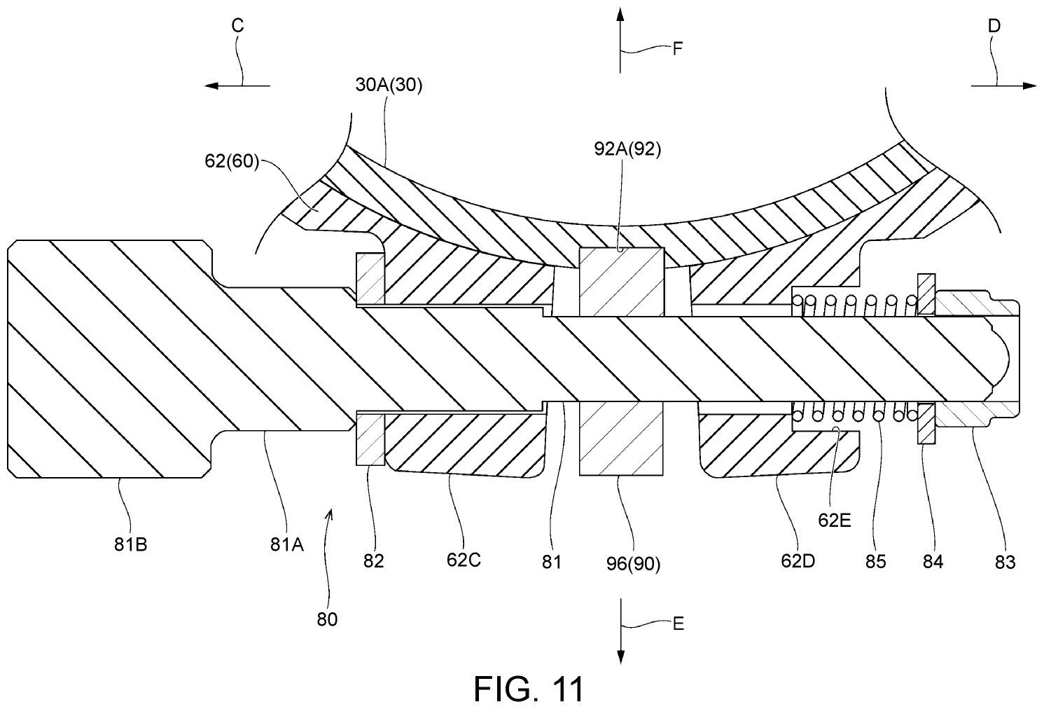

The holding mechanism 80 is configured as a mechanism holding the base 60 in a temporarily fixed state to the housing 22 in the released state of the fixing mechanism 70. Here, the temporarily fixed state in the present embodiment refers to the following state: when the base 60 does not fall to the cylinder part 22A of the housing 22 due to its own weight, and the lifting mechanism 90 described later is manually operated, the base 60 is held by the cylinder part 22A so that the base 60 is movable relative to the cylinder part 22A in the up-down direction. As shown in FIG. 1, FIG. 2 and FIG. 11, the holding mechanism 80 is configured to include a connecting shaft 81 and a holding spring 85 as an energization member.

The connecting shaft 81 is formed in a substantially stepped shaft shape with the first direction as the axial direction. Specifically, at one end of the connecting shaft 81, a stopper 81A one-step raised radially outward and an operation knob 81B one-step raised radially outward from the stopper 81A are formed. The operation knob 81B is arranged on one side in the first direction with respect to the stopper 81A. With the operation knob 81B and the stopper 81A protruding from the first clamp part 62C of the base 60 toward one side in the first direction, the connecting shaft 81 is bridged over between vertically intermediate portions of the first clamp part 62C and the second clamp part 62D so as to be relatively movable in the first direction and rotatable about its own axis. A first holding washer 82 is inserted into the connecting shaft 81 from the other end side. The first holding washer 82 is arranged between the stopper 81A and the first clamp part 62C. The stopper 81A is engaged with the first clamp part 62C via the first holding washer 82, and movement of the connecting shaft 81 toward the other side in the axial direction is restricted.

The other end of the connecting shaft 81 protrudes from the second clamp part 62D toward the other side in the first direction. A male thread is formed on an outer periphery of the other end of the connecting shaft 81. An adjustment nut 83 as a locking part is screwed to the other end of the connecting shaft 81. A second holding washer 84 is attached to the other end of the connecting shaft 81. The second holding washer 84 is arranged adjacent to the adjustment nut 83 on one side in the first direction.

The holding spring 85 is configured as a compression coil spring and attached to the other end portion of the connecting shaft 81. Specifically, one end of the holding spring 85 is locked by the second clamp part 62D, and the other end of the holding spring 85 is locked by the adjustment nut 83 via the second holding washer 84. The holding spring 85 energizes the second clamp part 62D toward one side in the first direction, and energizes the other end of the connecting shaft 81 toward the other side in the first direction.

Here, as described above, one end of the connecting shaft 81 is locked by the first clamp part 62C, and movement of the connecting shaft 81 toward the other end side is restricted. Hence, in the released state of the fixing mechanism 70, by energization force of the holding spring 85, the first clamp part 62C and the second clamp part 62D are displaced in directions approaching each other, so that the clamping force that tightens the cylinder part 22A of the housing 22 is generated in the base cylinder part 62. By the clamping force, frictional force is generated between the base 60 and the housing 22. The energization force of the holding spring 85 is set so that the base 60 is prevented from falling under its own weight by the frictional force. The following configuration is achieved: when the lifting mechanism 90 described later is actuated, an inner peripheral surface of the base cylinder part 62 of the base 60 slides on the outer peripheral surface of the outer cylinder part 30A of the outer case 30, and the base 60 moves relative to the housing 22 in the up-down direction. In the second clamp part 62D, a spring receptacle 62E (see FIG. 11) having a concave shape is formed open on the other side in the first direction. A portion of the holding spring 85 is accommodated in the spring receptacle 62E. By rotating the adjustment nut 83, the adjustment nut 83 performs relative movement in the axial direction of the connecting shaft 81. Thus, the energization force of the holding spring 85 can be adjusted by the adjustment nut 83.

(Regarding Lifting Mechanism 90)

As shown in FIG. 3, FIG. 10 and so on, the lifting mechanism 90 is configured to include the first rack 92 and the second rack 94 formed in the housing 22, the connecting shaft 81 of the holding mechanism 80, and a pinion 96. That is, the connecting shaft 81 is configured as a component of both the holding mechanism 80 and the lifting mechanism 90.

The pinion 96 is formed in a substantially cylindrical shape with the first direction as the axial direction, is fixed to an axially intermediate portion of the connecting shaft 81 so as to be integrally rotatable therewith, and is arranged coaxially with the connecting shaft 81. The connecting shaft 81 and the pinion 96 may be integrally formed and be configured as a single member. A width length of each of the first rack 92 and the second rack 94 along the circumferential direction of the cylinder part 22A of the housing 22 is set slightly greater than a width length (length in the axial direction) of the pinion 96.

A plurality of pinion teeth 96A are formed on an outer periphery of the pinion 96. The plurality of pinion teeth 96A are formed over the entire circumference of the pinion 96 in the circumferential direction. The following configuration is achieved: the pinion 96 is arranged between the first clamp part 62C and the second clamp part 62D of the base 60, the pinion tooth 96A is arranged in the rack groove 92A of the first rack 92 or in the rack groove 94A of the second rack 94 of the housing 22, and the pinion tooth 96A meshes with the rack tooth 92B or the rack tooth 94B (the pinion tooth 96A meshes with the rack tooth 92B in the example shown in FIG. 3).

Accordingly, the following configuration is achieved: in the released state of the fixing mechanism 70, by rotating the connecting shaft 81 about its own axis, the pinion 96 rotates relative to the first rack 92 (second rack 94), and the base 60 moves up and down in the up-down direction with respect to the housing 22. The pinion tooth 96A is arranged in the rack groove 92A (rack groove 94A). Hence, the following configuration is achieved: when the base 60 moves up and down with respect to the housing 22, by engaging the pinion tooth 96A with both longitudinal ends of the rack groove 92A (rack groove 94A), rotation of the base 60 relative to the housing 22 is restricted. The following configuration is achieved: after a lifting position of the base 60 is adjusted, by changing the fixing mechanism 70 from the released state to the fixed state, the base 60 is fixed to the adjusted position.

(Regarding Controller 100)

The controller 100 is accommodated inside the upper case part 28 of the housing 22 and fixed to the upper case part 28. The controller 100 includes the control part 101 and an inverter 110. The connector 32, the motor 34, the microswitch 44, the encoder 48, and the tact switch 54 are electrically connected to the controller 100. The following configuration is achieved: according to an operation on the trigger 42 and the lock button 50, the control part 101 controls actuation of the motor 34. The following configuration is achieved: according to the rotation position of the speed setting dial 46, the control part 101 controls the rotational speed of the motor 34.

<Electrical Configuration>

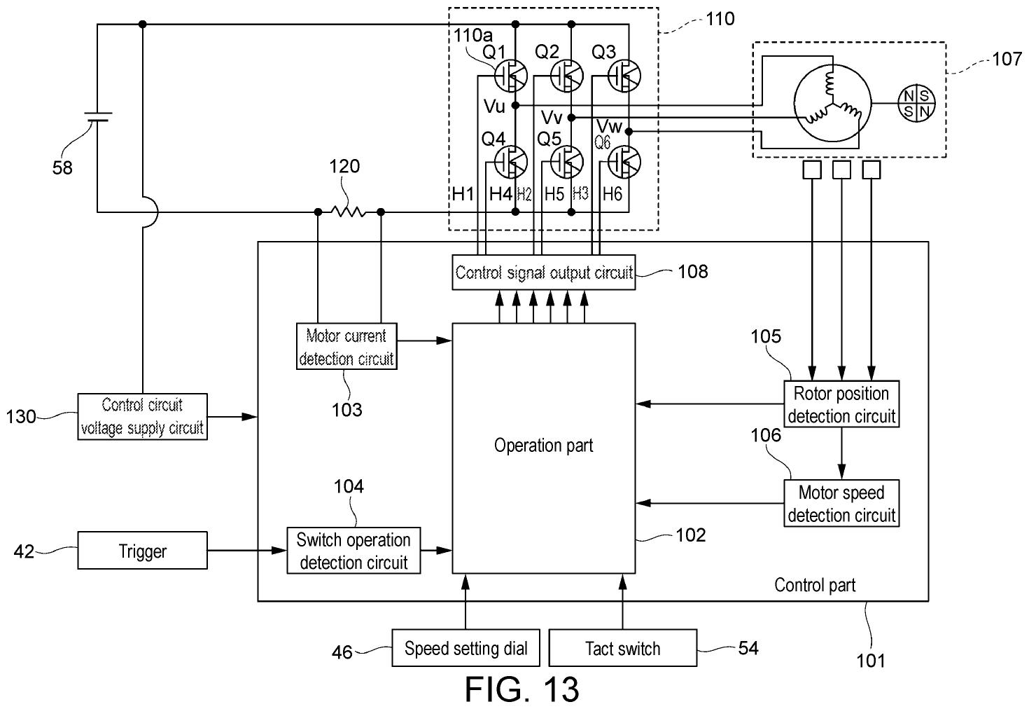

An electrical configuration of the electrically-powered trimmer 10 is described using a functional (circuit) block diagram of FIG. 13. The controller 100 includes a control circuit board (not shown), and the control part 101 and the inverter 110 are mounted on the control circuit board. The control part 101 includes an operation part 102. The operation part 102 performs various controls such as drive control of the inverter 110. The operation part 102 is a microcomputer. The inverter 110 is a circuit in which switching elements 110a (six switching elements 110a are provided in the present embodiment) are bridge-connected. A detection resistor 120 is provided in a path of a driving current of a brushless motor as the motor 34. A control circuit voltage supply circuit 130 converts a voltage of the battery 58 into a voltage suitable for an operation of the control part 101 and supplies it to the control part 101. A magnetic sensor 107 is, for example, a Hall element, and outputs a signal corresponding to a rotation position of the brushless motor as the motor 34.

In the control part 101, a motor current detection circuit 103 detects the driving current of the brushless motor as the motor 34 from a terminal voltage of the detection resistor 120. A switch operation detection circuit 104 detects an operation performed by the operator on the trigger 42 as the operating part. A rotor position detection circuit 105 detects the rotation position of the brushless motor as the motor 34 based on the signal from the magnetic sensor 107. A motor speed detection circuit 106 detects the rotational speed of the brushless motor as the motor 34 based on a signal from the rotor position detection circuit 105. The operation part 102 calculates the rotational speed of the brushless motor as the motor 34 based on a detection result of the rotor position detection circuit 105, and outputs the rotational speed to a control signal output circuit 108.

The control part 101 has different control states to change between a case where the tact switch 54 (lock button 50) as the state switcher is operated when the brushless motor as the motor 34 is in a non-driving state and a case where the tact switch 54 (lock button 50) as the state switcher is operated when the brushless motor as the motor 34 is in a driving state. For example, when the brushless motor as the motor 34 is in the driving state, the control part 101 has, as the control state, an on lock state in which driving of the brushless motor as the motor 34 is maintained even if the operation on the trigger 42 as the operating part is canceled and an on lock release state in which driving of the brushless motor as the motor 34 is stopped by canceling the operation on the trigger 42 as the operating part. The control part 101 may, for example, perform control to switch between the on lock state and the on lock release state based on an operation on the tact switch 54 (lock button 50) as the state switcher. For example, when in the on lock state, the control part 101 may perform control to release the on lock state based on the operation the trigger 42 as the operating part.

(Regarding Operation of Electrically-powered Trimmer 10)

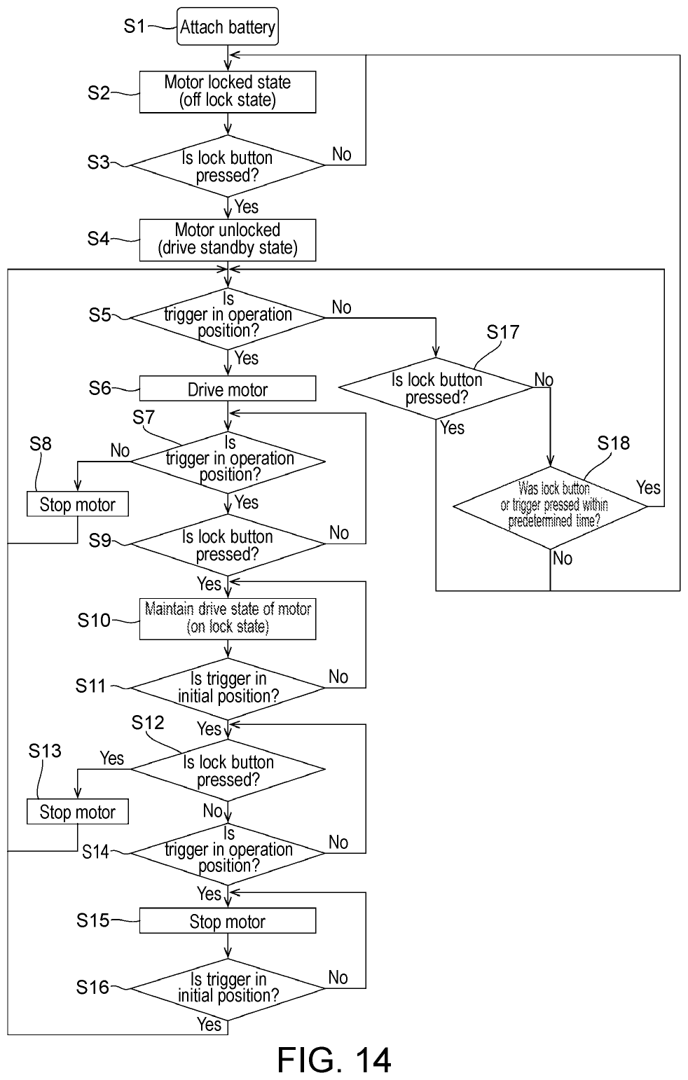

Next, an operation of the electrically-powered trimmer 10 is described using a flowchart shown in FIG. 14.

In the operation of the electrically-powered trimmer 10, in step 1 (S1), the battery 58 is attached to the battery mounting part 28A of the housing 22, and the battery 58 is connected to the connector 32. After the battery 58 is connected to the connector 32, the process proceeds to step 2 (S2).

In step 2, in the control part 101, a state (off lock state) is achieved in which driving of the motor 34 is prohibited. After the processing of step 2, the process proceeds to step 3 (S3).

In step 3, the control part 101 determines whether the lock button 50 has been pressed based on an output signal of the tact switch 54. If the lock button 50 has not been pressed in step 3 (No in step 3), the process returns to step 2. That is, the off lock state of the motor 34 is maintained. On the other hand, if the lock button 50 has been pressed in step 3 (Yes in step 3), the process proceeds to step 4 (S4).

In step 4, in the control part 101, a state (off lock release state, also referred to as a drive standby state of the motor 34) is achieved in which driving of the motor 34 is permitted. Then, after the processing of step 4, the process proceeds to step 5 (S5).

In step 5, the control part 101 determines whether the trigger 42 has been operated to the operation position based on an output signal of the microswitch 44. If the trigger 42 has been operated to the operation position in step 5 (Yes in step 5), the process proceeds to step 6.

In step 6, the motor 34 is driven by the control part 101. Accordingly, the output shaft 34A of the motor 34 rotates about its own axis, and the operator subjects the workpiece to cutting by the tip tool T. At this time, the control part 101 rotates the output shaft 34A at a rotational speed corresponding to the rotation position of the speed setting dial 46. After the processing of step 6, the process proceeds to step 7 (S7).

In step 7, the control part 101 determines whether the operation of operating the trigger 42 to the operation position is continued based on the output signal of the microswitch 44. In step 7, if the operation of operating the trigger 42 to the operation position is not continued, that is, if the trigger 42 has returned to the initial position (No in step 7), the process proceeds to step 8 (S8).

In step 8, the control part 101 stops driving of the motor 34. That is, if the operator cancels the operation on the trigger 42, the driving of the motor 34 is stopped. Then, after the processing of step 8, the process returns to step 5.

On the other hand, in step 7, if the operation of operating the trigger 42 to the operation position is continued (Yes in step 7), the process proceeds to step 9 (S9).

In step 9, the control part 101 determines whether the lock button 50 has been pressed based on the output signal from the tact switch 54. If the lock button 50 has not been pressed in step 9 (No in step 9), the process returns to step 7. On the other hand, if the lock button 50 has been pressed in step 9 (Yes in step 9), the process proceeds to step 10 (S10).

In step 10, the control part 101 achieves a state (on lock state) in which driving of the motor 34 is maintained. That is, when the lock button 50 is pressed while the trigger 42 is operated in the operation position, the process transitions to the on lock state in which driving of the motor 34 is maintained. After the processing of step 10, the process proceeds to step 11 (S11).

In step 11, the control part 101 determines whether the trigger 42 has returned to the initial position based on the output signal of the microswitch 44. If the trigger 42 has not returned to the initial position in step 11 (No in step 11), the process returns to step 10. That is, if the operation performed by the operator of operating the trigger 42 to the operation position is continued, the process returns to step 10 and the on lock state is maintained.

On the other hand, if the trigger 42 has returned to the initial position in step 11 (Yes in step 11), the process proceeds to step 12 (S12). That is, even if the operation performed by the operator on the trigger 42 is canceled, the on lock state of the motor 34 is maintained and the process proceeds to step 12.

In step 12, the control part 101 determines whether the lock button 50 has been pressed based on the output signal of the tact switch 54. If the lock button 50 has been pressed in step 12 (Yes in step 12), the process proceeds to step 13 (S13).

In step 13, driving of the motor 34 is stopped by the control part 101. That is, when the lock button 50 is pressed in the on lock state of the motor 34, the on lock state of the motor 34 is released and the motor 34 stops. Then, after the processing of step 13, the process returns to step 5.

On the other hand, if the lock button 50 has not been pressed in step 12 (No in step 12), the process proceeds to step 14 (S14).

In step 14, the control part 101 determines whether the trigger 42 has been operated to the operation position based on the output signal of the microswitch 44. If the trigger 42 has not been operated to the operation position in step 14 (No in step 14), the process returns to step 12. That is, the on lock state of the motor 34 is maintained. On the other hand, if the trigger 42 has been operated to the operation position in step 14 (Yes in step 14), the process proceeds to step 15 (S15).

In step 15, driving of the motor 34 is stopped by the control part 101. That is, in the on lock state of the motor 34, when the lock button 50 is not pressed and the trigger 42 is operated to the operation position again, the on lock state of the motor 34 is released and the motor 34 stops. Then, after the processing of step 15, the process proceeds to step 16 (S16).

In step 16, the control part 101 determines whether the trigger 42 has returned to the initial position based on the output signal of the microswitch 44. If the trigger 42 has not returned to the initial position in step 16 (No in step 16), the process returns to step 15. That is, the stop state of the motor 34 is maintained. On the other hand, if the trigger 42 has returned to the initial position in step 16 (Yes in step 16), the process returns to step 5. That is, if the operation performed by the operator on the trigger 42 is canceled, the process returns to step 5 while the motor 34 is stopped. Accordingly, as the trigger 42 is operated to the operation position again, the motor 34 is driven again by the control part 101.

On the other hand, if the trigger 42 has not been operated to the operation position in step 5 (No in step 5), the process proceeds to step 17 (S17).

In step 17, the control part 101 determines whether the lock button 50 has been pressed based on the output signal from the tact switch 54. If the lock button 50 has been pressed in step 17 (Yes in step 17), the process returns to step 2. That is, in the control part 101, the motor 34 is transitioned from the drive standby state to the off lock state. On the other hand, if the lock button 50 has not been pressed in step 17 (No in step 17), the process proceeds to step 18 (S18).

In step 18, the control part 101 determines whether the lock button 50 was pressed within a predetermined time (10 seconds in the present embodiment) based on the output signal from the tact switch 54. In step 18, the control part 101 determines whether the trigger 42 was operated to the operation position within the predetermined time based on the output signal from the microswitch 44. That is, in step 18, the control part 101 determines whether the operation on the lock button 50 or the trigger 42 was performed within the predetermined time.

If the operation on the lock button 50 or the trigger 42 was performed within the predetermined time in step 18 (Yes in step 18), the process returns to step 5. That is, the process returns to the drive standby state of the motor 34. On the other hand, if the operation on the lock button 50 or the trigger 42 was not performed within the predetermined time in step 18 (No in step 18), the process returns to step 2. That is, in the drive standby state of the motor 34, if the operation on the lock button 50 or the trigger 42 is not performed, the control part 101 causes the motor 34 to transition from the drive standby state to the off lock state.

(Effects)

Next, effects of the electrically-powered trimmer 10 of the present embodiment are described.

The electrically-powered trimmer 10 configured as above is configured to include: the housing 22, constituting the outer shell of the trimmer body 20; the inner case 24, including the inner cylinder part 26 having a cylindrical shape; and the outer case 30, externally inserted onto the inner case 24. The outer case 30 is fixed to the inner case 24. That is, the housing 22 has a double structure including the inner case 24 and the outer case 30. Hence, rigidity of the housing 22 can be increased. Moreover, the outer case 30 is composed of a disassemblable single member. The base cylinder part 62 of the base 60 is detachably and externally inserted onto the outer case 30. That is, a portion of the housing 22 directly supporting the base cylinder part 62 is composed of a disassemblable single member. Accordingly, support rigidity of the housing 22 with respect to the base cylinder part 62 can be increased. According to the above, a suitable fixing structure with respect to the base 60 can be realized.

In particular, the inner case 24 is made of resin, and the outer case 30 is made of metal. Hence, while a portion of the cylinder part 22A of the housing 22 that directly supports the base 60 is increased in strength, the cylinder part 22A can be reduced in weight.

The outer case 30 is formed in a substantially bottomed cylindrical shape open upward. The case bottom 30B of the outer case 30 is fastened and fixed to the fixing boss 26N of the inner case 24 by the fixing bolt BL. Furthermore, the fixing bolt BL and the fixing boss 26N for fixing the outer case 30 to the inner case 24 are arranged radially inside the outer peripheral surface of the outer cylinder part 30A. Accordingly, the size of the outer case 30 can be reduced compared to a configuration (hereinafter referred to as an electrically-powered trimmer of a comparative example) in which, for example, the upper end of the outer case 30 projects radially outward of the outer cylinder part 30A in the same manner as the upper case part 28 of the inner case 24, and the projecting portion is fastened and fixed to the upper case part 28 of the inner case 24. Accordingly, as the outer case 30 can be reduced in weight, the electrically-powered trimmer 10 as a whole can be reduced in weight. Compared to the electrically-powered trimmer of the comparative example, there is no longer a need to provide the fixing part for fixing the outer case 30 to the upper case part 28 of the inner case 24. Accordingly, as the upper case part 28 can be reduced in size, the electrically-powered trimmer as a whole can be reduced in size.

The upper case part 28 is provided at the upper end of the inner case 24. The upper case part 28 projects from the outer peripheral surface of the outer case 30 (outer cylinder part 30A) as viewed in the up-down direction. Accordingly, the controller 100 that drives and controls the motor 34 can be arranged in the upper case part 28 having a relatively large sectional area compared to the inner cylinder part 26. The battery mounting part 28A can be provided in the upper case part 28, and the battery 58 can be attached to the inner case 24.

A lower end portion of the output shaft 34A is supported by the second bearing 36L. The second bearing 36L is held by the bearing holder 26L of the inner case 24. The fixing boss 26N for fastening and fixing the outer case 30 is formed on the bearing holder 26L. Accordingly, the outer case 30 can be fastened and fixed to the inner case 24 by utilizing the bearing holder 26L that holds the second bearing 36L. In other words, the outer case 30 can be fastened and fixed to the inner case 24 by utilizing a region radially outside the second bearing 36L in the inner case 24.

The inner cylinder part 26 of the inner case 24 is configured to include the small diameter portion 26B and the large diameter portion 26A having a larger diameter than the small diameter portion 26B. An inner peripheral surface of the outer case 30 externally inserted onto the inner cylinder part 26 is in contact with the large diameter portion 26A. Accordingly, transfer of heat of the motor 34 operating in the inner cylinder part 26 to the outer case 30 can be suppressed by the gap 22B between the outer case 30 and the small diameter portion 26B. By the inner peripheral surface of the outer case 30 coming into contact with the large diameter portion 26A, rattling of the outer case in a state in which the outer case 30 is externally inserted onto the inner case 24 can be suppressed. Accordingly, while a temperature rise in the outer case 30 functioning as a grip gripped by the operator is suppressed, the state in which the outer case 30 is externally inserted onto the inner case 24 can be well maintained.

In the inner cylinder part 26 of the inner case 24, the large diameter portion 26A constitutes the upper end and the lower end of the inner cylinder part 26, and the small diameter portion 26B constitutes the vertically intermediate portion of the inner cylinder part 26. That is, the large diameter portion 26A is arranged on both axial sides of the inner cylinder part 26 with respect to the small diameter portion 26B. Accordingly, the outer case 30 can be supported by an axial end of the inner cylinder part 26. Accordingly, the state in which the outer case 30 is externally inserted onto the inner case 24 can be relatively well maintained.

The fan 40 rotated by driving the motor 34 is provided inside the inner case 24. Furthermore, the upper communication hole 26G and the lower communication hole 26H are formed in the large diameter portion 26A. Through the upper communication hole 26G and the lower communication hole 26H, the gap 22B and the inside of the inner case 24 communicate with each other. Accordingly, as shown in FIG. 3, when the electrically-powered trimmer 10 is actuated, the cooling air AR flows into the inner case 24 from the intake port 28B of the inner case 24 by the airflow generated by the fan 40. The cooling air AR that has flown into the inner case 24 is divided at the upper end of the inner cylinder part 26 into cooling air AR1 flowing into the upper communication hole 26G and cooling air AR2 flowing downward inside the inner cylinder part 26. The cooling air AR1 flows downward through the gap 22B between the small diameter portion 26B of the inner case 24 and the outer case 30, and flows into the lower end of the inner cylinder part 26 from the lower communication hole 26H. The cooling air AR1 and the cooling air AR2 join at the lower end of the inner cylinder part 26, and are discharged to the outside of the housing 22 from the inner exhaust port 26M and the outer exhaust port 30D. According to the above, while the outer case 30 is cooled by the cooling air AR1, the motor 34 can be cooled by the cooling air AR2. Accordingly, the outer case 30 and the motor 34 can be effectively cooled.

A pair of case gouged portions 30F open upward are formed at the upper end of the outer case 30. The trigger 42 provided in the inner case 24 is arranged inside one case gouged portion 30F, and the lock button 50 provided in the inner case 24 is arranged inside the other case gouged portion 30F. Accordingly, by matching positions of the case gouged portion 30F, the trigger 42 and the lock button 50, the outer case 30 can be externally inserted onto the inner case 24. In other words, when the outer case 30 is externally inserted onto the inner case 24, an orientation of the outer case 30 with respect to the inner case 24 in the circumferential direction can be aligned using the case gouged portion 30F, the trigger 42, and the lock button 50 as marks. Accordingly, operability in externally inserting the outer case 30 onto the inner case 24 can be improved.

The protrusion 26K protruding radially outward is formed in the inner cylinder part 26 of the inner case 24. The engagement groove 30G extending in the up-down direction and open upward is formed on the inner peripheral surface of the outer case 30. When the outer case 30 is externally inserted onto the inner case 24, the protrusion 26K is inserted into the engagement groove 30G, and the protrusion 26K and the engagement groove 30G are engaged in the circumferential direction of the outer case 30. Accordingly, rotation of the outer case 30 relative to the inner case 24 can be restricted. Thus, positional deviation between the fixing hole 30E and the fixing boss 26N when the fixing bolt BL is screwed to the fixing boss 26N can be suppressed. Accordingly, operability in fastening and fixing the outer case 30 to the inner case 24 can be improved.

The base 60 of the electrically-powered trimmer 10 is provided with the fixing mechanism 70 that switches between the fixed state in which the base 60 is fixed to the housing 22 and the released state in which the fixed state is released. Furthermore, the base 60 is provided with the holding mechanism 80. The holding mechanism 80 holds the base 60 in the temporarily fixed state to the housing 22 in the released state of the fixing mechanism 70. Specifically, the base 60 is held by the holding mechanism 80 so that the base 60 does not fall under its own weight in the released state of the fixing mechanism 70. That is, the holding mechanism 80 functions as a mechanism assisting the fixing mechanism 70 in the released state of the fixing mechanism 70, and the holding mechanism 80 prevents a fixing force of the base 60 with respect to the housing 22 from becoming zero immediately. As a result, there is no need for the operator to support the base 60 in the released state of the fixing mechanism 70. Accordingly, a suitable fixing structure with respect to the base 60 can be realized.

The holding mechanism 80 is configured to include the connecting shaft 81 connecting the first clamp part 62C and the second clamp part 62D of the base 60, and the holding spring 85. Specifically, the connecting shaft 81 is bridged over between the first clamp part 62C and the second clamp part 62D so as to be relatively movable in the axial direction. One end of the connecting shaft 81 is engaged with the first clamp part 62C, and movement of the connecting shaft 81 toward the other side in the axial direction is restricted. The holding spring 85 is attached to the other end portion of the connecting shaft 81, energizes the second clamp part 62D toward one side of the connecting shaft 81 in the axial direction, and energizes the other end of the connecting shaft 81 toward the other side in the axial direction. Accordingly, by the connecting shaft 81 and the holding spring 85, the first clamp part 62C and the second clamp part 62D are pressed inward of the connecting shaft 81 in the axial direction, and the base cylinder part 62 is deformed in a direction in which the first clamp part 62C and the second clamp part 62D approach each other.

More specifically, if the holding mechanism 80 is omitted from the electrically-powered trimmer 10, since a pressing force of the holding spring 85 on the second clamp part 62D disappears, the second clamp part 62D (see the second clamp part 62D indicated by a chain dashed line in FIG. 11) of the base 60 in the released state is greatly displaced toward the other side in the first direction with respect to the second clamp part 62D (see the second clamp part 62D indicated by a chain double-dashed line in FIG. 11) of the base 60 in the fixed state. In contrast, by providing the holding mechanism 80 in the base 60, the pressing force of the holding spring 85 acts on the second clamp part 62D. Thus, the second clamp part 62D (see the second clamp part 62D indicated by a solid line in FIG. 11) of the base 60 in the released state is located on one side in the first direction compared to the case where the holding mechanism 80 is omitted. Hence, the clamping force with which the base cylinder part 62 tightens the cylinder part 22A of the housing 22 and clamps the cylinder part 22A is generated in the base 60. As a result, frictional force is generated between the base cylinder part 62 and the cylinder part 22A, and the base 60 can be held in a temporarily held state by the frictional force. The term “temporarily held state” herein indicates a state in which the subject is fixed to the extent that it can be moved by hand while its movement under its own weight is suppressed.

In the holding mechanism 80, the adjustment nut 83 is screwed to the other end of the connecting shaft 81. The holding spring 85 is arranged between the second clamp part 62D and the adjustment nut 83. Accordingly, by rotating the adjustment nut 83 relative to the connecting shaft 81, the energization force of the holding spring 85 against the second clamp part 62D and the connecting shaft 81 can be easily adjusted.

The pinion 96 of the lifting mechanism 90 is provided on the connecting shaft 81 so as to be integrally rotatable therewith. The pinion 96 meshes with the first rack 92 or the second rack 94 of the outer case 30. Accordingly, in the released state of the fixing mechanism 70, by rotating the operation knob 81B of the connecting shaft 81, the base 60 can be moved up and down with respect to the housing 22. That is, the connecting shaft 81 can be configured as a common part to the holding mechanism 80 and the lifting mechanism 90. Accordingly, compared to the case where the connecting shaft 81 is not configured as a common part to the holding mechanism 80 and the lifting mechanism 90, space occupied by the holding mechanism 80 and the lifting mechanism 90 can be reduced, and the driving tool 10 can be reduced in size.

As described above, one end (stopper 81A) of the connecting shaft 81 is engaged with the first clamp part 62C via the first holding washer 82, and movement of the connecting shaft 81 toward the other side in the axial direction is restricted. Furthermore, the holding spring 85 energizes the other axial end of the connecting shaft 81 toward the other side in the axial direction. Accordingly, a shaft holding force for restricting rotation of the connecting shaft 81 by the energization force of the holding spring 85 is generated in the connecting shaft 81. As described above, the pinion 96 is rotatably provided on the connecting shaft 81 so as to be integrally rotatable therewith, and the pinion 96 meshes with the first rack 92 or the second rack 94 of the outer case 30. Hence, the shaft holding force generated in the connecting shaft 81 is able to act on a portion where the pinion 96 meshes with the first rack 92 or the second rack 94. That is, the lifting mechanism 90 is also able to function as a mechanism that holds the base 60 in the temporarily fixed state to the housing 22. Accordingly, the energization force of the holding spring 85 can be effectively utilized and the base 60 can be held in the temporarily fixed state.

The first rack 92 and the second rack 94 of the lifting mechanism 90 are arranged apart in the circumferential direction of the outer cylinder part 30A. Hence, in the circumferential direction of the cylinder part 22A, a position (hereinafter referred to as first position) of the base 60 when the pinion 96 meshes with the first rack 92 and a position (hereinafter referred to as second position) of the base 60 when the pinion 96 meshes with the second rack 94 can be set to different positions. Hence, the lifting mechanism 90 is able to function with the base 60 arranged in the first position or the second position according to a work mode of the operator. Accordingly, operability with respect to the operator can be improved.

As described above, in the circumferential direction of the cylinder part 22A of the housing 22, a plurality of racks (first rack 92 and second rack 94) are formed in the outer cylinder part 30A. Furthermore, the width length of each of the first rack 92 and the second rack 94 along the circumferential direction of the cylinder part 22A is set greater than the width length of the pinion 96. Hence, an entire rack length (the sum of the width lengths of the first rack 92 and the second rack 94) along the circumferential direction of the cylinder part 22A is set to be at least twice the width length of the pinion 96. That is, the term “entire rack length along the circumferential direction of a cylinder part” in the present invention refers to, if a plurality of racks (first rack 92 and second rack 94) are formed in the outer cylinder part 30A, the sum of width lengths of the plurality of racks (first rack 92 and second rack 94), as in the present embodiment. Accordingly, as described above, the position of the base 60 in the circumferential direction of the outer cylinder part 30A can be changed and the lifting mechanism 90 can be utilized.

In the present embodiment, since the trigger 42 is provided in the outer cylinder part 30A (grip), the motor 34 can be quickly turned on and off during work with one hand. Even if a gripped state is released during operation of the trigger 42, since the motor 34 stops, damage to the workpiece can be reduced. Furthermore, since the motor 34 can be maintained in the on state by an operation on the lock button 50, work can be continued even if an operating force on the trigger 42 is canceled, and fatigue during work can be reduced. Since off lock control can be executed so that, as long as the lock button 50 is not operated, the motor 34 will not be driven even if the trigger 42 is operated, even if foreign matter comes into contact with the trigger 42 when no work is being performed, the motor 34 is not driven, and an adverse effect such as wasteful energy consumption can be reduced. Furthermore, by a configuration in which transition to the on lock state can be performed in the same manner by the lock button 50 that releases the off lock state, the number of parts of a control switch can be reduced, and the transition from the off lock release state to the on lock state can be performed in the same gripped state. In particular, in the present embodiment, since it is possible to make a transition from the off lock release state to the on lock state by an operation with two fingers in the gripped state, operability can be greatly improved.

In the present embodiment, by inserting the fixing bolt BL into the fixing hole 30E of the outer case 30 from below and screwing the fixing bolt BL to the fixing boss 26N of the inner case 24, the outer case 30 is fastened and fixed to the inner case 24. That is, the fixing bolt BL extends in the up-down direction. Alternatively, for example, the fixing bolt BL may be arranged at a lower end of the cylinder part 22A so as to extend in the first direction or the second direction, and the inner case 24 and the outer case 30 may be fastened and fixed.

In the holding mechanism 80 of the present embodiment, the clamping force that clamps the cylinder part 22A of the housing 22 is generated in the base 60, and the base 60 is held in the temporarily fixed state to the housing 22. However, a mechanism holding the base 60 in the temporarily fixed state is not limited to the above. For example, although illustration is omitted, at least one of the outer peripheral surface of the outer cylinder part 30A of the outer case 30 and the inner peripheral surface of the base cylinder part 62 of the base 60 may be provided with a high friction member having a relatively high friction coefficient, and the base 60 may be held in the temporarily fixed state by frictional force generated between the base cylinder part 62 and the outer cylinder part 30A. The holding spring 85 is located on the outer periphery of the connecting shaft 81 and configured to bring the first clamp part 62C and the second clamp part 62D close to each other. However, the holding spring 85 may also be provided on the fixing shaft 71. For example, the following configuration is possible: while the fixing pin 76 is increased in size in the axial direction, the holding spring 85 is interposed between the fixing pin 76 and the second fixing washer 74, and energization force is exerted on the fixing pin 76 and the second fixing washer 74.

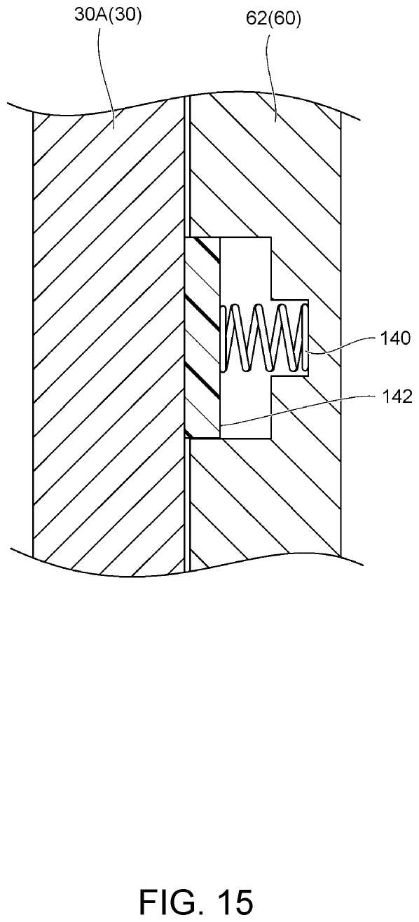

For example, as shown in FIG. 15, one of the outer cylinder part 30A and the base cylinder part 62 may be provided with a holding spring 140 and a pressing member 142 as energization members, frictional force may be generated between the outer cylinder part 30A and the base cylinder part 62, and the base 60 may be held in the temporarily fixed state by the frictional force (in the example shown in FIG. 15, the holding spring 140 and the pressing member 142 are provided in the base cylinder part 62). Specifically, a recess open toward the outer cylinder part 30A is formed in the base cylinder part 62, and the holding spring 140 and the pressing member 142 are arranged in the recess. The holding spring 140 is configured as a compression coil spring, and presses the pressing member 142 toward the outer cylinder part 30A. Accordingly, frictional force is generated between the pressing member 142 and the outer cylinder part 30A, and the base 60 can be held in the temporarily fixed state. Although a material of the pressing member 142 is not particularly defined, a holding force with respect to the base 60 can further be increased by using an elastic member such as rubber.

In the present embodiment, two racks (first rack 92 and second rack 94) are formed in the outer cylinder part 30A of the housing 22. However, three or more racks may be formed in the outer cylinder part 30A, or one rack may be formed in the outer cylinder part 30A. If one rack is formed in the outer cylinder part 30A, the width length of the rack along the circumferential direction of the cylinder part 22A is set to be at least twice the width length of the pinion 96. For example, the width of the rack is set to ½ of the entire circumference of the outer cylinder part 30A. Accordingly, in this case, the entire rack length along the circumferential direction of the cylinder part 22A is set to be at least twice the width length of the pinion 96. Hence, even if one rack is formed in the outer cylinder part 30A, the position of the base 60 in the circumferential direction of the outer cylinder part 30A can be changed by the lifting mechanism 90.

In the present embodiment, the first rack 92 and the second rack 94 are formed in the housing 22, and the pinion 96 is provided in the base 60. However, a configuration is possible in which the pinion 96 is provided in the housing 22 and the first rack 92 and the second rack 94 are formed in the base 60.

In the electrically-powered trimmer 10 configured as described above, the fixing mechanism 70 is provided that switches between the fixed state in which the base 60 is fixed to the housing 22 and the released state in which the fixed state is released. The fixing mechanism 70 is configured to include the upper-lower pair of fixing shafts 71 bridged over between the first clamp part 62C and the second clamp part 62D of the base 60, a pair of cam parts 75B connected to the other end of the fixing shaft 71, and a pair of fixing washers (second fixing washers) 74 provided at the other end of the fixing shaft 71.

When the clamp lever 75 of the fixing mechanism 70 is rotated from the release position toward the fixing position, the cam surface 75C of the cam part 75B contacts the washer contact part 74A of the second fixing washer 74, and presses the washer contact part 74A toward one side in the first direction. Accordingly, the washer pressing part 74B of the second fixing washer 74 presses the second clamp part 62D toward one side in the first direction. In the rotation of the clamp lever 75 toward the fixing position, a pressing amount of the cam part 75B to the second fixing washer 74 increases as the clamp lever 75 is rotated. On the other hand, one end of the fixing shaft 71 is engaged with the first clamp part 62C via the fixing nut 72 and the first fixing washer 73 (engagement washer 73), and movement of the fixing shaft 71 toward the other side in the axial direction is restricted. Hence, in the fixing position of the clamp lever 75, a pressing force (corresponding to the fixing force of the present invention) is imparted from the second fixing washer 74 to the second clamp part 62D. Accordingly, the second clamp part 62D is displaced toward the first clamp part 62C, and the base cylinder part 62 is deformed. As a result, the clamping force that tightens the cylinder part 22A of the housing 22 is generated in the base cylinder part 62, and the base 60 is fixed to the housing 22 by the clamping force.

Here, in the fixing mechanism 70, the fixing shaft 71 is bridged over between the upper end and the lower end of each of the first clamp part 62C and the second clamp part 62D of the base 60. The cam part 75B and the second fixing washer 74 are provided on each of the pair of fixing shafts 71. Accordingly, both longitudinal ends of the first clamp part 62C and the second clamp part 62D can be sandwiched by the fixing mechanism 70. In other words, in the fixed state of the fixing mechanism 70, the pressing force input to the second clamp part 62D from the second fixing washer 74 for deforming the base cylinder part 62 acts on each of an upper portion (upper end) and a lower portion (lower end) of the second clamp part 62D. Hence, compared to, for example, a configuration (hereinafter, the electrically-powered trimmer of this configuration is referred to as the electrically-powered trimmer of the comparative example) in which the pressing force imparted from the second fixing washer 74 to the second clamp part 62D is imparted to one place in a longitudinal intermediate portion of the second clamp part 62D, the base cylinder part 62 can be well deformed over the entire axial direction. Accordingly, compared to the electrically-powered trimmer of the comparative example, the clamping force of the base cylinder part 62 that clamps the cylinder part 22A is able to act uniformly in the axial direction of the base cylinder part 62. Accordingly, the base 60 can be stably fixed to the housing 22. In particular, in the present embodiment, since the pressing force acting on the upper portion and the lower portion of the second clamp part 62D acts in a range of 30% of the upper portion and 30% of the lower portion in an extension range of the second clamp part 62D, the possibility that the fixing force at upper and lower ends of the second clamp part 62D may be insufficient can be reduced. Furthermore, in the case where the lower portion of the second clamp part 62D is located below the lower end of the inner cylinder part 26, although there is a possibility that the fixing force with respect to the lower portion of the second clamp part 62D may be insufficient, attenuation of the fixing force can be compensated for by the pressing force acting on the upper portion of the second clamp part 62D. In the present embodiment, the pressing force is generated in the upper portion (upper end) and the lower portion (lower end) of the second clamp part 62D by the pair of fixing shafts 71. However, a means may be provided of generating a pressing force in the upper portion and the lower portion of the second clamp part 62D while there is only one fixing shaft.

The fixing mechanism 70 includes the clamp lever 75, and the clamp lever 75 includes an upper-lower pair of cam parts 75B. In other words, the pair of cam parts 75B connected to the fixing shaft 71 are connected by the clamp lever 75. Accordingly, by rotating the clamp lever 75, the pair of cam parts 75B can be actuated at the same time. Accordingly, even if the fixing mechanism 70 is configured to include a pair of fixing shafts 71, a pair of second fixing washers 74, and a pair of cam parts 75B, complexity for the operator when operating the fixing mechanism 70 can be reduced.

The connecting groove 71A open toward the other side in the axial direction is formed at the other end of the fixing shaft 71. The cam part 75B is arranged in the connecting groove 71A and is rotatably connected with the fixing shaft 71. Accordingly, compared to, for example, a configuration in which the connecting groove 71A is omitted from the fixing shaft 71, a pair of cam parts 75B are arranged on both sides of the fixing shaft 71 in the up-down direction with respect to one fixing shaft 71, and the cam part 75B and the fixing shaft 71 are connected, an increase in size of the fixing mechanism 70 in the up-down direction can be suppressed.

The second fixing washer 74 is configured to include the washer contact part 74A extending in the second direction, and the washer pressing part 74B formed in an annular shape and to which both longitudinal ends of the washer contact part 74A are connected. The washer contact part 74A is inserted into the connecting groove 71A of the fixing shaft 71 and configured to be able to contact the cam part 75B. The washer pressing part 74B is externally inserted onto the fixing shaft 71 and configured to be able to press the second clamp part 62D. Accordingly, the pressing force of the cam part 75B on the second fixing washer 74 is input to a central portion of the second fixing washer 74, the input pressing force is uniformly transmitted in the circumferential direction of the washer pressing part 74B, and the second clamp part 62D can be pressed by the washer pressing part 74B.

The base cylinder part 62 is provided with the connecting shaft 81 between the upper-lower pair of fixing shafts 71. The pinion 96 constituting the lifting mechanism 90 is provided on the connecting shaft 81 so as to be integrally rotatable therewith. The pinion 96 meshes with the first rack 92 or the second rack 94 formed in the outer case 30. Accordingly, a region between the upper-lower pair of fixing shafts 71 can be effectively utilized, and the lifting mechanism 90 for changing the position of the base 60 with respect to the housing 22 can be provided.

(Regarding Modification 1 of Fixing Mechanism 70)

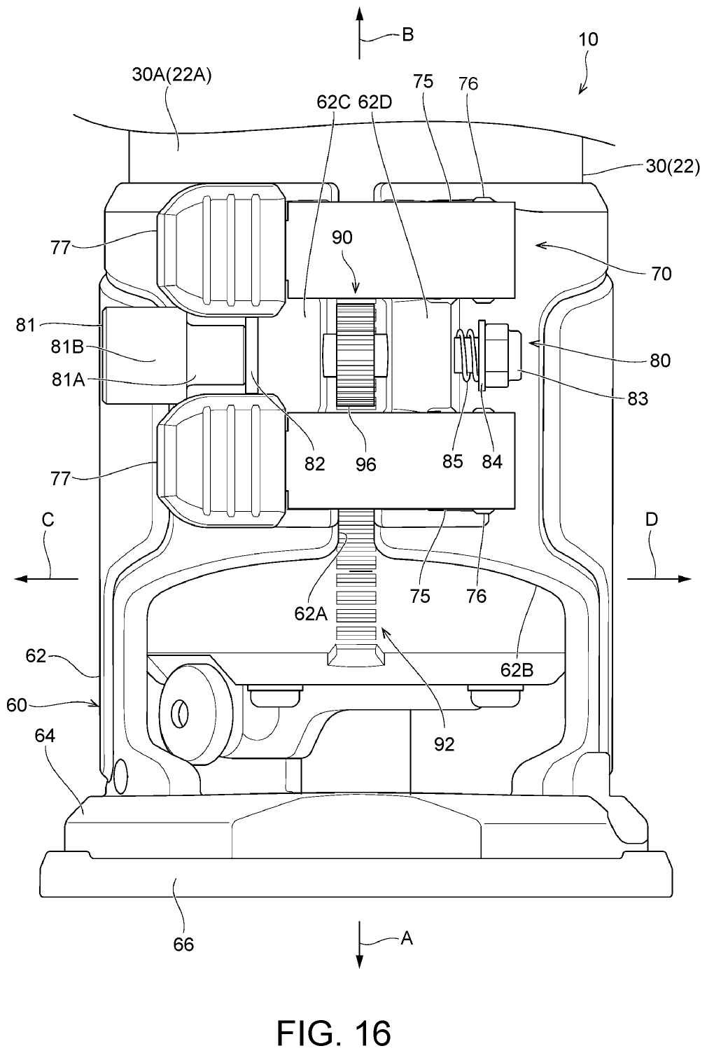

Modification 1 of the fixing mechanism 70 is described below with reference to FIG. 16. Modification 1 of the fixing mechanism 70 is configured in the same manner as the fixing mechanism 70 of the present embodiment except for the following points. That is, in Modification 1 of the fixing mechanism 70, a pair of clamp levers 75 are provided corresponding to a pair of fixing shafts 71 (not shown in FIG. 16). The clamp lever 75 is formed in a substantially rectangular shape with the first direction as the longitudinal direction as viewed from one side in the second direction. Although illustration is omitted, the connecting groove 71A is omitted from the fixing shaft 71. The cam part of the clamp lever 75 is arranged above and below the other end of the fixing shaft 71, and is rotatably connected to the fixing shaft 71 by the fixing pin 76 with the up-down direction as the axial direction. The washer contact part 74A is omitted from the fixing washer 74.

By rotating the upper and lower clamp levers 75 from the release position to the fixing position, as in the present embodiment, both longitudinal ends of the first clamp part 62C and the second clamp part 62D of the base cylinder part 62 can be sandwiched by the fixing mechanism 70. Accordingly, the clamping force of the base cylinder part 62 that clamps the cylinder part 22A is able to act uniformly in the axial direction of the base cylinder 62. Accordingly, in Modification 1 of the fixing mechanism 70, the base 60 can be stably fixed to the housing 22.

In Modification 1 of the fixing mechanism 70, the clamp lever 75 is provided corresponding to each of the pair of fixing shafts 71. Hence, the pressing force imparted from the fixing washer 74 on the upper side to the second clamp part 62D and the pressing force imparted from the fixing washer 74 on the lower side to the second clamp part 62D can be fine-tuned.

In Modification 1, the fixing mechanism 70 includes two fixing shafts 71, two cam parts two fixing washers 74, and two clamp levers 75. However, the fixing mechanism 70 may be configured to include three or more of each component.

(Regarding Modification 2 of Fixing Mechanism 70)

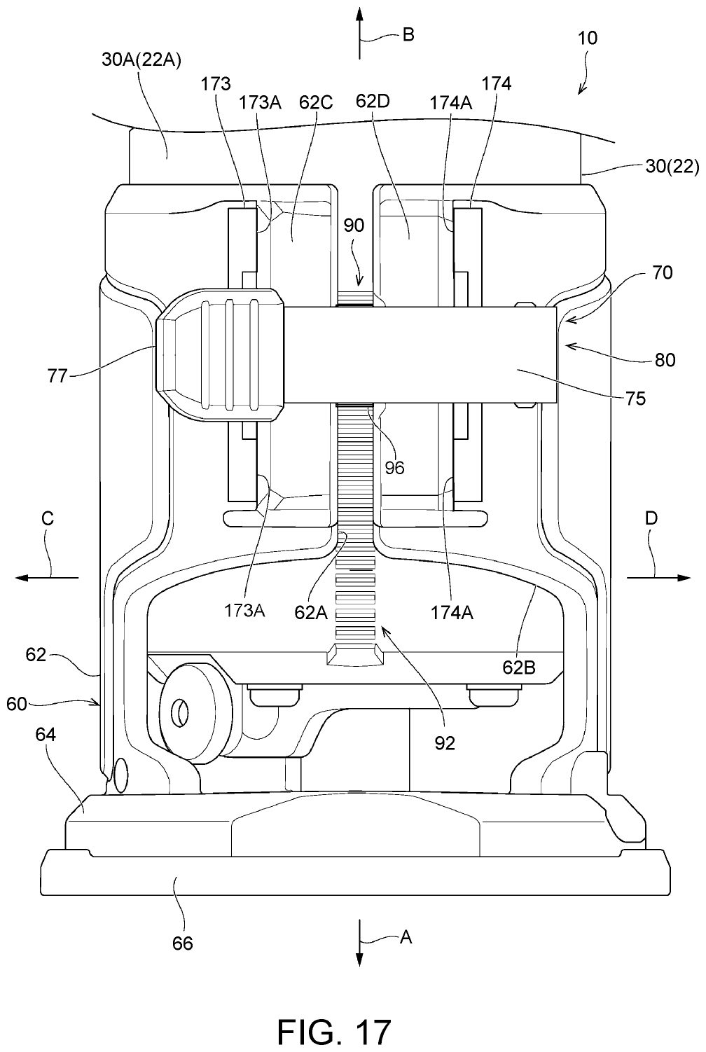

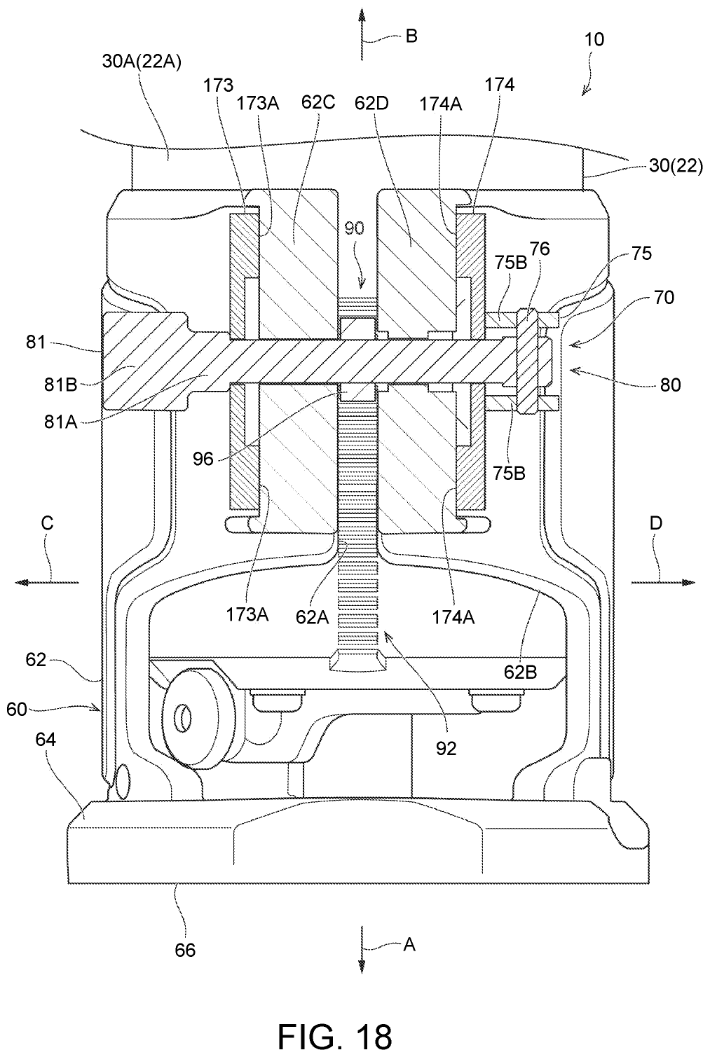

Modification 2 of the fixing mechanism 70 is described below with reference to FIG. 17 and FIG. 18. Modification 2 of the fixing mechanism 70 is configured in the same manner as the fixing mechanism of the present embodiment except for the following points. That is, in Modification 2 of the fixing mechanism 70, instead of the pair of fixing shafts 71, the connecting shaft 81 of the holding mechanism 80 is configured as a fixing shaft of the fixing mechanism 70. In Modification 2 of the fixing mechanism 70, the clamp lever 75 is formed in a substantially rectangular shape with the first direction as the longitudinal direction as viewed from one side in the second direction. The cam part of the clamp lever 75 is arranged above and below the other end of the fixing shaft 71, and is rotatably connected to the fixing shaft 71 by the fixing pin 76 with the up-down direction as the axial direction.

In Modification 2, instead of the first fixing washer 73 (engagement washer 73), an engagement washer 173 is provided at one end of the connecting shaft 81. The engagement washer 173 is formed in a substantially rectangular plate shape with the first direction as the plate thickness direction and the up-down direction as the longitudinal direction. One end portion of the connecting shaft 81 is inserted through a longitudinal intermediate portion of the engagement washer 173, and the stopper 81A of the connecting shaft 81 is engaged with the engagement washer 173. A restriction part 173A is formed at both longitudinal ends of the engagement washer 173. The restriction part 173A protrudes toward the other side in the first direction and is in contact with the upper end and the lower end of the first clamp part 62C. Accordingly, movement of the connecting shaft 81 toward the other side in the second direction is restricted.

In Modification 2, instead of the fixing washer 74, a fixing washer 174 as a pressing member is provided at the other end of the connecting shaft 81. The fixing washer 174 is formed in a substantially rectangular plate shape with the first direction as the plate thickness direction and the up-down direction as the longitudinal direction. The other end portion of the connecting shaft 81 is inserted through a longitudinal intermediate portion of the fixing washer 174, and the fixing washer 174 is arranged between the second clamp part 62D and the cam part 75B of the clamp lever 75. In the fixed state of the fixing mechanism 70, the cam part 75B may press the fixing washer 174 toward one side in the first direction.

A pushing part 174A as a fixing force imparting part is formed at both longitudinal ends of the fixing washer 174. The pushing part 174A protrudes toward one side in the first direction and is arranged adjacent to the upper end and the lower end of the second clamp part 62D on the other side in the first direction.

When the clamp lever 75 of the fixing mechanism 70 is rotated from the release position to the fixing position, the cam part 75B presses the fixing washer 174 toward one side in the first direction. Accordingly, a pair of pushing parts 174A of the fixing washer 174 presses the upper end and the lower end of the second clamp part 62D toward one side in the first direction. Hence, in the second embodiment, both longitudinal ends of the first clamp part 62C and the second clamp part 62D of the base cylinder part 62 can be sandwiched by the fixing mechanism 70. Accordingly, the clamping force of the base cylinder part 62 that clamps the cylinder part 22A is able to act uniformly in the axial direction of the base cylinder part 62. Accordingly, in Modification 2 of the fixing mechanism 70, the base 60 can be stably fixed to the housing 22.

That is, in Modification 2 of the fixing mechanism 70, the connecting shaft 81 of the holding mechanism 80 is configured as the fixing shaft of the fixing mechanism 70. Hence, the number of parts can be reduced, and the cost of the electrically-powered trimmer 10 can be reduced.

In the present embodiment, the fixing mechanism 70 is configured to impart the pressing force to the second clamp part 62D, and the clamping force that tightens the cylinder part 22A of the housing 22 is configured to act on the base cylinder part 62. However, the configuration of the fixing mechanism 70 is not limited thereto. For example, although illustration is omitted, the fixing mechanism 70 may be configured as a toggle mechanism, and the fixing force imparting parts that impart the fixing force for fixing the cylinder part 22A may be arranged apart in the up-down direction.

### DESCRIPTION OF REFERENCE NUMERALS

10: electrically-powered trimmer (work machine); 24: inner case; 26: inner cylinder part; 26A: large diameter portion; 26B: small diameter portion; 26G: upper communication hole (communication part); 26H: lower communication hole (communication part); 26K: protrusion; 26L: bearing holder; 26N: fixing boss (fixing part); 28: upper case part (overhang); 28A: battery mounting part (battery attachment and detachment part); 30: outer case; 30F: case gouged portion (recess); 30G: engagement groove (groove); 34: motor; 34A: output shaft; 36L: second bearing (bearing); 40: fan; 42: trigger (operating part); 44: microswitch (switch); 58: battery (battery); 60: base; 100: controller; T: tip tool

1. A work machine comprising:
a motor;
an output shaft rotated by the motor, to which a tip tool is attachable;
a housing, configured to comprise an inner case comprising an accommodation part that accommodates the motor and an outer case located outside the accommodation part; and
a base, attachable to and detachable from a mounting surface formed on a side surface of the outer case and having a contact surface able to contact a workpiece,
wherein
the inner case is provided with a fixing part, the outer case is fixed to the inner case by a fixing member attached to the fixing part, and the fixing part is arranged inside the mounting surface in a radial direction of the motor as viewed in an axial direction of the motor.

2. A work machine comprising:
a motor;
an output shaft rotated by the motor and extending in an axial direction, to which a tip tool is attachable;
a housing, configured to comprise an inner case comprising an accommodation part that accommodates the motor and an outer case located outside the accommodation part; and
a base, attachable to and detachable from a mounting surface formed on a side surface of the outer case and having a contact surface able to contact a workpiece,
wherein
the inner case is inserted into the outer case toward one side in the axial direction, a fixing member restricting movement of the outer case toward the other side in the axial direction is provided on the one side of the accommodation part, and an overhang is connected to the other side of the accommodation part; and
the overhang projects from the mounting surface as viewed in the axial direction of the motor.

3. The work machine according to claim 1, wherein
an overhang is connected to the other side of the accommodation part in the axial direction of the motor, and the overhang projects radially outward of the mounting surface as viewed in the axial direction of the motor.

4. The work machine according to claim 2, wherein
the inner case comprises a fixing part to which the fixing member is attached on one side of the accommodation part in the axial direction; and
the fixing part is arranged inside the mounting surface in a radial direction of the motor as viewed in the axial direction of the motor.

5. The work machine according to claim 3, wherein
the accommodation part is an inner cylinder part having a cylindrical shape;
the outer case is a disassemblable single member and is formed in a cylindrical shape;
the inner case is inserted inside the outer case; and
the fixing part is provided at one end of the inner case in the axial direction of the motor.

6. The work machine according to claim 2, wherein
a controller controlling the motor is accommodated in the overhang, and the controller projects radially outward of an outer peripheral surface of the outer case as viewed in the axial direction of the outer case.

7. The work machine according to claim 3, wherein
the overhang is provided with a battery attachment and detachment part to which a battery supplying electric power to the motor is attached, and the battery attachment and detachment part projects outward of the mounting surface as viewed in the axial direction.

8. The work machine according to claim 5, wherein
a bearing supporting the output shaft is provided inside the inner cylinder part, and the inner case is provided with a bearing holder holding the bearing; and
the fixing part is formed on the bearing holder.

9. The work machine according to claim 5, wherein
the inner cylinder part is configured to comprise a small diameter portion and a large diameter portion having a larger diameter than the small diameter portion; and
an outer peripheral surface of the large diameter portion is in contact with the outer case.

10. The work machine according to claim 9, wherein
the large diameter portion is provided on each of both axial sides of the motor with respect to the small diameter portion.

11. The work machine according to claim 9, wherein
a fan rotated by driving the motor is provided inside the inner case; and
an airflow generated by the fan flows through between the small diameter portion and the outer case.

12. The work machine according to claim 10, wherein
a communication part is formed in the large diameter portion, and the communication part communicates inside of the inner case with a space between the small diameter portion and the outer case.

13. The work machine according to claim 5, wherein
a recess open toward the other side in the axial direction is formed at the other end of the outer case in the axial direction; and
the inner case is provided with an operating part performing an on or off operation of the motor, and the operating part is arranged in the recess.

14. The work machine according to claim 13, wherein
a protrusion protruding outward in the radial direction is formed in the inner cylinder part, and a groove fitted with the protrusion and restricting rotation of the outer case with respect to the inner case is formed in the outer case.

15. The work machine according to claim 13, wherein
the operating part is configured to be able to be pressed radially inward of the inner cylinder part, and the operating part is operated to thereby press a switch provided inside the inner cylinder part.

16. The work machine according to claim 4, wherein
the accommodation part is an inner cylinder part having a cylindrical shape;
the outer case is a disassemblable single member and is formed in a cylindrical shape;
the inner case is inserted inside the outer case; and
the fixing part is provided at one end of the inner case in the axial direction of the motor.
